(19) United States
(12) Patent Application Publication
(10) Pub. No.: US 2007/0120532 A1
(43) Pub. Date: May 31, 2007

(54) Driving device and method of driving plasma displays

(76) Inventors: Joon-Yeon Kim, Yongin-si (KR); Hak-Cheol Yang, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/605,303

(22) Filed: Nov. 29, 2006

(30) Foreign Application Priority Data
Nov. 30, 2005 (KR) 10-2005-0115855
Nov. 30, 2005 (KR) 10-2005-0115856
Nov. 30, 2005 (KR) 10-2005-0115857

(51) Int. Cl. H02J 7/00

(52) U.S. Cl. 320/130

(57) ABSTRACT

A driver circuit including first and second transistors between a first power source and a second power source, third and fourth transistors between the second power source and a third power source supplying a third voltage, a first charging power source between the first power source and the first and second transistors, a first charging path between the first power source and the first charging power source, a second charging power source between the third power source and the second transistors, a second charging path between the third power source and the second charging power source, a fifth transistor between the first electrodes and the first charging path and the first charging power source, a sixth transistor between the first electrodes and the second charging path and the second charging power source, an inductor having a first terminal coupled to the first electrodes, and a path separator.

### BACKGROUND OF THE INVENTION

1. Field of the Invention

The present invention relates to a plasma display device and a driving method thereof.

2. Description of the Related Art

A plasma display panel (PDP) is a flat panel display that uses plasma generated by gas discharge to display characters or images. It includes a plasma display panel (PDP) wherein tens to millions of discharge cells are arranged in a matrix format, depending on its size.

On a panel of the plasma display device, a field, e.g., 1 TV field, is divided into a plurality of subfields that each have a weight assigned thereto. Grayscales are expressed by a combination of the weights of the corresponding subfields, which are used to perform a display operation. Each subfield has an address period in which an address operation for selecting discharge cells to emit light from among a plurality of discharge cells occurs, and a sustain period in which a sustain discharge occurs in the selected discharge cells to perform a display operation.

Because a high level voltage and a low level voltage are alternately applied to an electrode to perform a sustain discharge during a sustain period, a transistor for applying the high level and low level voltages must have a withstand voltage corresponding to at least a difference between the high level and low level voltages. Such a transistor having a high withstand voltage increases the cost of a sustain discharge driving circuit.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention is therefore directed to a plasma display device and a driving method thereof, which substantially overcome one or more of the problems due to the limitations and disadvantages of the related art.

It is therefore a feature of embodiments of the invention to provide a sustain discharge driving circuit employing a transistor having a low withstand voltage relative to conventional sustain discharge driving circuits.

It is therefore a separate feature of embodiments of the invention to provide a lower cost sustain discharge driving circuit relative to conventional sustain discharge driving circuits by employing a transistor(s) having a lower withstand voltage.

It is therefore a separate feature of embodiments of the invention to provide a method of driving a display panel using a sustain discharge driving circuit employing a transistor(s) having a low withstand voltage relative to conventional sustain discharge driving circuits.

At least one of the above and other features and embodiments of the invention may be realized by providing a driver circuit for a display device including a plurality of first electrodes, the driver circuit including a first and a second transistor coupled in series between a first power source for supplying a first voltage and a second power source for supplying a second voltage that is lower than the first voltage, a third and a fourth transistor coupled in series between the second power source and a third power source for supplying a third voltage that is lower than the second voltage, a first charging power source coupled between the first power source and a node of the first and second transistors, a first charging path being coupled between the first power source and the first charging power source, for charging the first charging power source when the second transistor is turned on, a second charging power source coupled between the third power source and a node of the third and fourth transistors, a second charging path being coupled between the third power source and the second charging power source, for charging the second charging power source when the third transistor is turned on, a fifth transistor coupled between the plurality of first electrodes and a node of the first charging path and the first charging power source, a sixth transistor coupled between the plurality of first electrodes and a node of the second charging path and the second charging power source, at least one inductor having a first terminal coupled to the plurality of first electrodes, and at least one path separator having a first node coupled to one of the first charging power source, the second charging power source, and the second power source, and a second node coupled to a second terminal of the one inductor, for separating a first current path from the first node to the second node and a second current path from the second node to the first node, wherein the first node is coupled to the second power source in the case of the at least one path separator being a single separator and the first node is coupled to the first and second charging power source in the case of the at least one path separator being a plurality of separators.

The first current path may include a seventh transistor having a first terminal coupled to the first node and a first diode having an anode coupled to a second terminal of the seventh transistor and a cathode coupled to the second terminal of the inductor, and the second current path may include an eighth transistor having a second terminal coupled to the first node and a second diode having a cathode coupled to a first terminal of the eighth transistor and an anode coupled to the second terminal of the inductor.

The number of path separators may be equal to the number of inductors. In the case of there being two path separators, the first and second charging power sources may respectively include first and second capacitors for charging a same voltage and that are coupled in series, and a first node of the respective path separators may be coupled to a node of the first and second capacitors. In the case of there being two path separators, the first and second charging power sources may respectively include a third capacitor, the first node of the one path separator is coupled to a node of the first and second transistors, and the first node of the other path separator may be coupled to a node of the third and fourth transistors.

The first charging path includes a third diode having an anode coupled to the first power source and a cathode coupled to the first charging power source. The second charging path may include a fourth diode having a cathode coupled to the third power source and an anode coupled to the second charging power source. In the case of there being one path separator, the fourth and sixth transistors may be turned on and the plurality of first electrodes are applied with a fourth voltage corresponding to a difference between the third voltage and a voltage charged at the second capacitor, the sixth transistor may be turned off and a seventh transistor is turned on so that the voltage of the plurality of first electrodes is increased to a fifth voltage that is higher than the fourth voltage, the fourth transistor may then be turned off and the first transistor may be turned on so that the voltage of the plurality of first electrodes is additionally increased to a sixth voltage that is higher than the fifth voltage, and the seventh transistor may be turned off and the fifth transistor is turned on so that the plurality of first electrodes is applied with a voltage corresponding to the sum of the first voltage and the voltage charged at the first capacitor.

The plurality of first electrodes may be applied with the fourth voltage and the second transistor is turned on while the voltage of the plurality of first electrodes may be increased from the fourth voltage to the fifth voltage so that the first capacitor charges a voltage corresponding to a difference between the first voltage and the second voltage, and the third transistor may be turned on while the voltage of the plurality of first electrodes is increased from the fifth voltage to the sixth voltage so that the second capacitor is charged at a voltage corresponding to a difference between the second voltage and the third voltage. While the first and fifth transistors are turned on and the plurality of first electrodes may be applied with a fourth voltage corresponding to a difference between the first voltage and a voltage charged at the first capacitor, the fifth transistor may be turned off and an eighth transistor may be turned on so that the voltage of the plurality of first electrodes is decreased to a fifth voltage that is lower than the fourth voltage, the first transistor is then turned off and the fourth transistor is turned on so that the voltage of the plurality of first electrodes is additionally decreased to a sixth voltage that is lower than the fifth voltage, and the eighth transistor may be turned off and the sixth transistor is turned on and the plurality of first electrodes is applied with a voltage corresponding to the sum of the first voltage and the voltage charged at the second capacitor.

The plurality of first electrodes may be applied with the fourth voltage and the third transistor is turned on while the voltage of the plurality of first electrodes is decreased from the fourth voltage to the fifth voltage so that the second capacitor is charged at a voltage corresponding to a difference between the first voltage and the second voltage, and the second transistor is turned on while the voltage of the plurality of first electrodes is decreased from the fifth voltage to the sixth voltage so that the first capacitor is charged at a voltage corresponding to a difference between the first voltage and the second voltage.

While the fourth and sixth transistors are turned on and the plurality of first electrodes are applied with a fourth voltage corresponding to a difference between the third voltage and a voltage charged at the second capacitor, the sixth transistor is turned off and a ninth transistor is turned on so that the voltage of the plurality of first electrodes is increased to a fifth voltage, the fourth transistor and the ninth transistor may then be turned off and the first transistor and the seventh transistor are turned on so that the voltage of the plurality of first electrodes is additionally increased to a sixth voltage that is higher than the fourth voltage, and the seventh transistor may be turned off and the fifth transistor may be turned on so that the plurality of first electrodes may be applied with a voltage corresponding to the sum of the first voltage and the voltage charged at the first capacitor.

The plurality of first electrodes may be applied with the fourth voltage and the second transistor is turned on while the voltage of the plurality of first electrodes may be increased from the fourth voltage to the fifth voltage so that the first capacitor may be charged at a voltage corresponding to a difference between the first voltage and the second voltage, and the third transistor may be turned on while the voltage of the plurality of first electrodes is increased from the fifth voltage to the sixth voltage so that the second capacitor is charged at a voltage corresponding to a difference between the second voltage and the third voltage.

While the first and fifth transistors are turned on and the plurality of first electrodes are applied with a fourth voltage corresponding to a difference between the first voltage and a voltage charged at the first capacitor, the fifth transistor may be turned off and the eighth transistor may be turned on so that the voltage of the plurality of first electrodes is decreased to a fifth voltage that is lower than the fourth voltage, and the first transistor and the eighth transistor may then be turned off and the fourth transistor and a tenth transistor may be turned on so that the voltage of the plurality of first electrodes may be additionally decreased to a sixth voltage that is lower than the fifth voltage, and the tenth transistor may be turned off and the sixth transistor may be turned on so that the plurality of first electrodes are applied with a voltage corresponding to the sum of the third voltage and the voltage charged at the second capacitor.

The plurality of first electrodes may be applied with the fourth voltage and the third transistor may be turned on while the voltage of the plurality of first electrodes is decreased to the fifth voltage so that the second capacitor may be charged at a voltage corresponding to a difference between the second voltage and the third voltage, and the second transistor may be turned on while the voltage of the plurality of first electrodes is decreased from the fifth voltage to the sixth voltage so that the first capacitor is charged at a voltage corresponding to a difference between the first voltage and the second voltage.

While the fourth and sixth transistors are turned on and the plurality of first electrodes are applied with a fourth voltage corresponding to a difference between the third voltage and a voltage charged at the second capacitor, the sixth transistor may be turned off and a ninth transistor may be turned on so that the voltage of the plurality of first electrodes is increased, and the fourth transistor may then be turned off and the third transistor may be turned on so that the voltage of the plurality of first electrodes may be additionally increased to the fifth voltage that is higher than the fourth voltage, the third and ninth transistors may be turned off and the second and seventh transistors are turned on so that the voltage of the plurality of first electrodes is additionally increased, the second transistor may be turned off and the first transistor may be turned on so that the voltage of the plurality of first electrodes is additionally increased to the sixth voltage that is higher than the fifth voltage, and the seventh transistor may be turned off and the fifth transistor may be turned on so that the plurality of first electrodes are applied with a voltage corresponding to the sum of the first voltage and the voltage charged at the first and second capacitors.

The plurality of first electrodes may be applied with the fourth voltage and the second transistor may be turned on while the voltage of the plurality of first electrodes is increased from the fourth voltage to the fifth voltage so that the first and second capacitors may be charged at a voltage corresponding to a difference between the first voltage and the second voltage, and the third transistor may be turned on while the voltage of the plurality of first electrodes is increased from the fifth voltage to the sixth voltage so that the third and fourth capacitors are charged at a voltage corresponding to a difference between the second voltage and the third voltage.

While the first and fifth transistors are turned on so that the plurality of first electrodes are applied with a fourth voltage corresponding to the sum of the first voltage and a voltage charged at the first and second capacitors, the fifth transistor may be turned off and the eighth transistor may be turned on so that the voltage of the plurality of first electrodes may be decreased, the first transistor may then be turned off and the second transistor is turned on so that the voltage of the plurality of first electrodes is additionally decreased to the fifth voltage that is lower than the fourth voltage, the second and eighth transistors may be turned off and the third transistor and a tenth transistor are turned on so that the voltage of the plurality of first electrodes is additionally decreased, the third transistor may be turned off and the fourth transistor is turned on so that a voltage of the plurality of first electrodes is additionally decreased to the sixth voltage (−Vs) that is lower than the fifth voltage, and the tenth transistor may be turned off and the sixth transistor may be turned on so that the plurality of first electrodes may be applied with a voltage corresponding to a difference between the third voltage and the voltage charged at the third and fourth capacitors.

The plurality of first electrodes may be applied with the fourth voltage and the third transistor may be turned on while the voltage of the plurality of first electrodes is decreased from the fourth voltage to the fifth voltage so that the third and fourth capacitors are charged at a voltage corresponding to a difference between the second voltage and the third voltage, and the second transistor may be turned on while the voltage of the plurality of first electrodes is decreased from the fifth voltage to the sixth voltage so that the first and second capacitors are charged at a voltage corresponding to a difference between the first voltage and the second voltage.

At least one of the above and other features and embodiments of the invention may be separately realized by providing a driving method for driving a display including a plurality of first electrodes and a plurality of second electrodes, the driving method including applying a third voltage to the plurality of first electrodes through a first power source for supplying a first voltage and a first capacitor charged at a second voltage, increasing a voltage of the plurality of first electrodes through a first resonance path including a second power source for supplying a fourth voltage that is higher than the first voltage and a first inductor by forming a first path including the first capacitor and the first power source, additionally increasing a voltage of the plurality of first electrodes through the first resonance path by forming a second path including a third power source for supplying a fifth voltage that is higher than a fourth voltage and a second capacitor charged at a sixth voltage, applying a seventh voltage corresponding to the sum of the fifth and sixth voltages to the plurality of first electrodes, decreasing a voltage of the plurality of first electrodes through a second resonance path including a second inductor and the second power source by forming a third path including the third power source and the second capacitor, and additionally decreasing a voltage of the plurality of first electrodes through the second resonance path by forming a fourth path including the first capacitor and the first power source.

The first resonance path may further include a first transistor coupled between the second power source and the first inductor, and the second resonance path further comprises a second transistor coupled between the second power source and the second inductor. The first resonance path may further include a third transistor between a first terminal of the first capacitor and the plurality of first electrodes and the second resonance path further includes a fourth transistor between a first terminal of the second capacitor and the plurality of first electrodes. Applying the third voltage to the plurality of first electrodes and forming the first path includes charging a sixth voltage at the second capacitor through a first charging path including the third power source, the second capacitor, and the second power source, and forming the second path includes charging a second voltage at the first capacitor through a second charging path including the second power source, the first capacitor, and the first power source.

Applying the seventh voltage to the plurality of first electrodes and forming the third path may include charging a second voltage at the first capacitor through the second charging path, and forming the fourth path includes charging a sixth voltage at the second capacitor through the first charging path.

At least one of the above and other features and embodiments of the invention may be separately realized by providing a driving method for driving a display including a plurality of first electrodes and a plurality of second electrodes, the driving method including applying a third voltage to the plurality of first electrodes through a first power source for supplying a first voltage and a first capacitor charged at a second voltage, increasing a voltage of the plurality of first electrodes through a first resonance path including the first power source and a first inductor, additionally increasing a voltage of the plurality of first electrodes through a second resonance path including a second power source for supplying a fourth voltage that is higher than the first voltage and a second inductor, applying a sixth voltage to the plurality of first electrodes through the second power source and a second capacitor charged at a fifth voltage, decreasing a voltage of the plurality of first electrodes through a third resonance path including the second power source and the second inductor, and additionally decreasing a voltage of the plurality of first electrodes through a fourth resonance path including the first inductor and the first capacitor.

The first resonance path may further include a first transistor coupled between the second power source and the first inductor, the second resonance path may further include a second transistor coupled between the second power source and the second inductor, the third resonance path may further include a third transistor coupled between the second power source and the second inductor, and the fourth resonance path may further include a fourth transistor coupled between the first power source and the first inductor.

Increasing or decreasing the voltage of the plurality of first electrodes through the first and fourth paths may include charging the fifth voltage at the second capacitor through a charging path including the second power source, the second capacitor, and the third power source for supplying a seventh voltage that is higher than the first voltage and lower than the fourth voltage. Increasing or decreasing the voltage of the plurality of first electrodes through the second and third paths may include charging the second voltage at the first capacitor through a charging path including the third power source, the first capacitor, and the first power source.

At least one of the above and other features and embodiments of the invention may be separately realized by providing a driving method for driving a display including a plurality of first electrodes and a plurality of second electrodes, the driving method including applying a third voltage to the plurality of first electrodes through a first power source for supplying a first voltage and first and second capacitors charged at a second voltage, increasing a voltage of the plurality of first electrodes through a first resonance path including the first power source and a first inductor, additionally increasing a voltage of the plurality of first electrodes through a second resonance path including a second power source for supplying a fourth voltage that is higher than the first voltage and the first inductor, additionally increasing a voltage of the plurality of first electrodes through a third resonance path including the second power source and a second inductor, additionally increasing a voltage of the plurality of first electrodes through a second resonance path including a third power source for supplying a fifth voltage that is higher than the fourth voltage and the second inductor, applying a seventh voltage to the plurality of first electrodes through the third power source, third capacitor, and fourth capacitor, the third and fourth capacitors being charged at a sixth voltage, decreasing a voltage of the plurality of first electrodes through a fifth resonance path including the third power source and the second inductor, additionally decreasing a voltage of the plurality of first electrodes through a sixth resonance path including the second power source and the second inductor, additionally decreasing a voltage of the plurality of first electrodes through a seventh resonance path including the second power source and the first inductor; and additionally increasing a voltage of the plurality of first electrodes through an eighth resonance path including the first power source and the first inductor.

The first resonance path further may include a first transistor coupled between the first power source and the first inductor, the second resonance path may further include the first transistor coupled between the second power source and the first inductor, the third resonance path may include a second transistor coupled between the second power source and the second inductor, the fourth resonance path may further include the second transistor coupled between the second power source and the second inductor, the fifth resonance path may further include a third transistor coupled between the third power source and the second inductor, the sixth resonance path further comprises the third transistor coupled between the second power source and the second inductor, the seventh resonance path may further include a fourth transistor coupled between the second power source and the first inductor, and the eighth resonance path may further include the fourth transistor coupled between the first power source and the first inductor.

Increasing or decreasing the voltage of the plurality of first electrodes through the first, second, seventh, or eighth paths may include charging the sixth voltage at the third and fourth capacitors through a charging path including the third power source, the third and fourth capacitors, and the second power source.

Increasing or decreasing the voltage of the plurality of first electrodes through the first, second, seventh, or eighth paths may include charging the second voltage at the first and second capacitors through a charging path including the second power source, the first and second capacitors, and the first power source.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 shows a schematic diagram of a plasma display device employable with exemplary embodiments of the present invention;

FIGS. 2 to 4 respectively show first, second and third exemplary driving waveforms for driving a plasma display employing one or more aspects of the present invention;

FIG. 5 shows a sustain discharge driving circuit of a sustain electrode driver according to a first exemplary embodiment of the present invention;

FIG. 6 shows an exemplary timing diagram employable by the first exemplary embodiment of the sustain discharge driving circuit shown in FIG. 5;

FIG. 7A to FIG. 7F respectively show exemplary current paths corresponding to respective operation modes of the first exemplary embodiment of the sustain discharge driving circuit shown in FIG. 5;

FIG. 8 shows a sustain discharge driving circuit of a sustain electrode driver according to a second exemplary embodiment of the present invention;

FIG. 9 shows an exemplary timing diagram employable by the second exemplary embodiment of the sustain discharge driving circuit shown in FIG. 8;

FIG. 10A to FIG. 10F respectively show exemplary current paths corresponding to respective operation modes of the second exemplary embodiment of the sustain discharge driving circuit shown in FIG. 8;

FIG. 11 shows a sustain discharge driving circuit of a sustain electrode driver according to a third exemplary embodiment of the present invention;

FIG. 12 shows an exemplary timing diagram employable by the third exemplary embodiment of the sustain discharge driving circuit shown in FIG. 11; and

FIG. 13A to FIG. 13J respectively show exemplary current paths corresponding to respective operation modes of the third exemplary embodiment of the sustain discharge driving circuit shown in FIG. 11.

### DETAILED DESCRIPTION OF THE INVENTION

Korean Patent Application Nos. 10-2005-0115855, 10-2005-0115856, and 10-2005-0115857 filed on Nov. 30, 2005, in the Korean Intellectual Property Office, and entitled: “Plasma Display, and Driving Device and Method Thereof,” is incorporated by reference herein in its entirety.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and claims which follow, unless explicitly described to the contrary, the word “a coupled state of one element to another element” includes a coupled state in which the two elements are directly coupled as well as a coupled state in which the two elements are electrically coupled with another element provided between them. In addition, the word “comprise/include” or variations such as “comprises/includes” or “comprising/including” will be understood to imply the inclusion of stated elements, but not the exclusion of any other elements.

In addition, the expression “maintained at a predetermined voltage” should not be understood as “maintained exactly at a predetermined voltage.” To the contrary, even if a voltage difference between two points varies, the voltage difference is expressed to be maintained at a predetermined voltage in the case that the variance is within a range allowed in design constraints, or in the case that the variance is caused due to a parasitic component that is usually disregarded by a person of ordinary skill in the art. A threshold voltage of a semiconductor element, e.g., a transistor, a diode and the like, is quite low compared to a discharge voltage, and therefore, the threshold voltage is approximated to 0 V in the following description.

Exemplary embodiments of a sustain discharge driving device, a driving method and a plasma display device according to one or more aspects of the invention will be described with reference to the accompanying Figures.

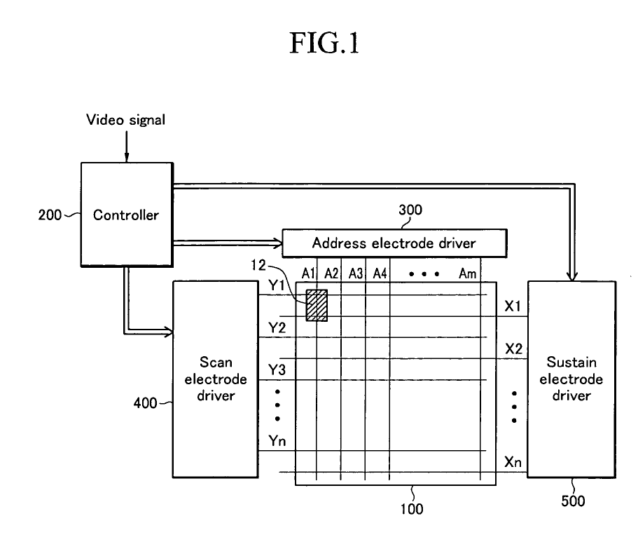

FIG. 1 shows a schematic diagram of a plasma display device employable with exemplary embodiments of the present invention. More particularly, e.g., the plasma display device illustrated in FIG. 1 may employ a driving circuit employing one or more aspects of the invention and/or may be driven by a driving method employing one or more aspects of the invention. As shown in FIG. 1, the plasma display device according to the exemplary embodiment of the present invention may include a plasma display panel (PDP) 100, a controller 200, an address electrode driver 300, a scan electrode driver 400, and a sustain electrode driver 500.

The PDP 100 may include a plurality of address electrodes A1-Am (hereinafter referred to as “A electrodes”) extending in a first direction, e.g., a column direction, and scan electrodes Y1-Yn (hereinafter referred to as Y electrodes) and sustain electrodes X1-Xn (hereinafter referred to as X electrodes) extending in a second direction, e.g., a row direction. The sustain electrodes X1-Xn may be formed in respective correspondence to the scan electrodes Y1-Yn, and the X and Y electrodes may perform a display operation for displaying an image(s) during a sustain period. The first direction may cross, e.g., perpendicularly, the second direction such that the address electrodes A1-Am may perpendicularly cross the scan electrodes Y1-Yn and sustain electrodes X1-Xn. Discharge spaces may be formed at regions where the address electrodes A1-Am cross the sustain and scan electrodes X1-Xn and Y1-Yn, and such discharge spaces may form discharge cells 12.

Such a general structure of the PDP 100 is illustrated and described as an example, and other embodiments of the invention may provide and/or employ a plasma display panel having other structures capable of employing a sustain discharge driving circuit employing one or more aspects of the invention and/or carrying a sustain discharge driving method employing one or more aspects of the invention.

The controller 200 may receive an external video signal, may output an A electrode driving control signal, an X electrode driving control signal, and a Y electrode driving control signal, and may control the plasma display device by dividing a frame into a plurality of subfields having respective brightness weight values. Each subfield may include a reset period, an address period, and a sustain period according to time intervals.

After receiving the A electrode driving control signal from the controller 200, the address electrode driver 300 may apply display data signals, for selecting respective ones of the discharge cells 12 to be displayed, to the respective address electrodes A1-Am.

The scan electrode driver 400 may apply a driving voltage to the Y electrodes after receiving the Y electrode driving control signal from the controller 200, and the sustain electrode driver 500 may apply a driving voltage to the X electrodes after receiving the X electrode driving control signal from the controller 200.

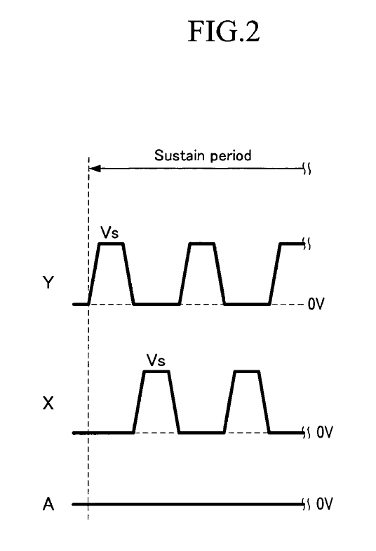

A plasma display configured as described above according to an exemplary embodiment of the present invention may be operated using various types of driving methods, and more particularly, various types of driving waveforms. FIGS. 2 to 4 respectively show first, second and third exemplary driving waveforms employable by first, second and third exemplary embodiments of the present invention.

In the following description, for convenience, only a part, i.e., a sustain period, of exemplary driving waveforms that may be applied to X, Y, and A electrodes for driving a single discharge cell 12 will be described with reference to the exemplary driving waveform portions illustrated in FIGS. 2 to 4.

As shown in FIG. 2, during a sustain period of the first exemplary embodiment of a driving circuit and/or driving method, a sustain pulse according to the first exemplary driving waveform may include alternately applying a high level voltage (voltage Vs) and a low level voltage (0 V) to respective Y and X electrodes in an inverse phase. That is, e.g., during the sustain period, a voltage of 0 V may be applied to the X electrode when a voltage Vs is applied to the Y electrode, and when the voltage Vs is applied to the corresponding X electrode, the voltage of 0 V may be applied to the corresponding Y electrode. Accordingly, a voltage difference between the X and Y electrodes during such a sustain period may alternate between the voltages Vs and −Vs, and accordingly, the sustain discharges may be repeated a predetermined number of times corresponding to a weight value of the corresponding subfield.

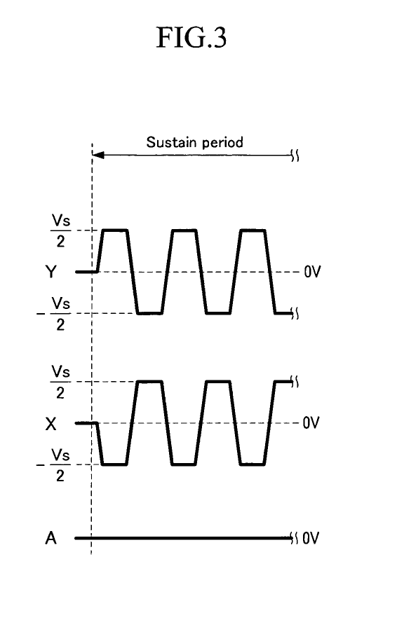

As shown in FIG. 3, during a sustain period of the second exemplary embodiment of a driving circuit and/or driving method, a sustain pulse according to the second exemplary driving waveform may include alternately applying a high level voltage, e.g., a voltage Vs/2, and a low level voltage, e.g., a voltage −Vs/2, to respective Y and X electrodes in an inverse phase. That is, e.g., during the sustain period, the voltage −Vs/2 may be applied to the X electrode when the voltage Vs/2 is applied to the Y electrode, and the voltage Vs/2 may be applied to the X electrode when the voltage −Vs/2 is applied to the Y electrode. Accordingly, a voltage difference between the X and Y electrodes during such a sustain period may alternate between Vs and −Vs voltages, the same as the sustain pulse of FIG. 2.

It is but one example that the scan electrode driver 400 and the sustain electrode driver 500 apply a sustain pulse to the X and Y electrodes. For example, in some embodiments, only one of the scan electrode driver 400 and the sustain electrode driver 500 may apply a sustain pulse to one electrode.

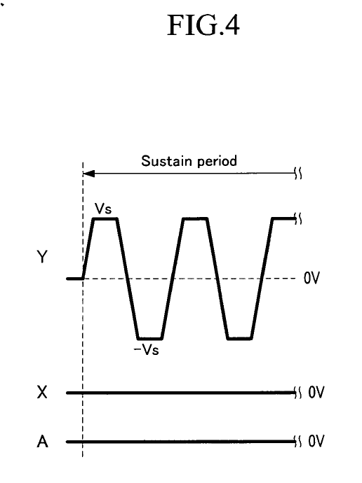

Such an exemplary embodiment may be described in detail with reference to FIG. 4. FIG. 4 shows the third exemplary driving waveform in the case that one of the scan electrode driver 400 and the sustain electrode driver 500 generates a sustain pulse. More particularly, e.g., the scan electrode driver 400 may generate a sustain pulse according to the third exemplary driving waveform illustrated in FIG. 4.

As shown in FIG. 4, during a sustain period of the third exemplary embodiment of a driving circuit and/or driving method, a sustain pulse according to the third exemplary driving waveform may include alternately applying a high level voltage, e.g., the voltage Vs, and a low level voltage, e.g., a voltage −Vs, to, e.g., the Y electrode, while the voltage of 0 V is applied to the X electrode. Accordingly, voltage differences between the X and Y electrodes during such a sustain period may alternate between Vs and −Vs, the same as the sustain pulses of FIG. 2 and FIG. 3.

Three exemplary types of sustain discharge driving circuits for generating sustain pulses according to, e.g., the first, second and/or third exemplary driving waveforms are described hereinafter. The sustain discharge driving circuit may be provided at the scan electrode driver and/or sustain electrode driver. More particularly, the sustain discharge driving circuit may be provided at the scan electrode driver or the sustain electrode driver, depending on, e.g., which of the exemplary first, second and third driving waveforms is employed.

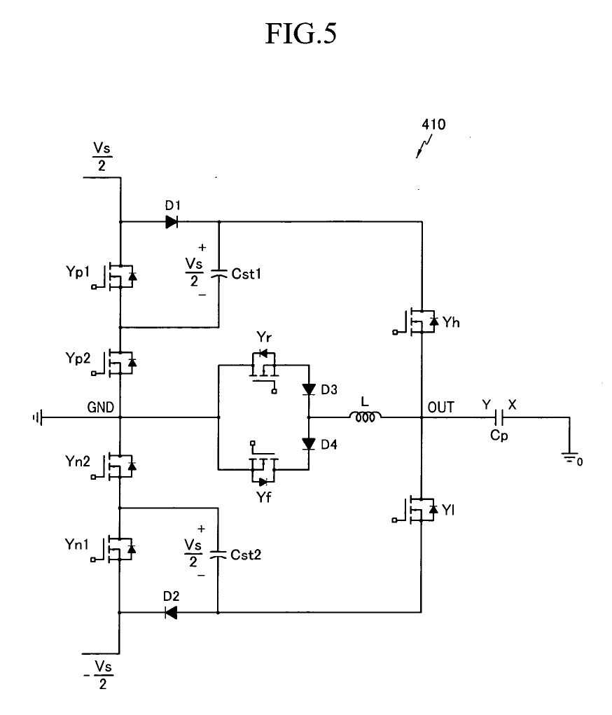

A first exemplary embodiment of a sustain discharge driving circuit and operation thereof will be described with regard to FIGS. 5, 6 and 7A to 7F. Hereinafter, generation of the third driving waveform will be described, and then generation of the first and second driving waveforms will be described.

The first exemplary embodiment of the sustain discharge driving circuit shown in FIG. 5 may have a power source voltage level that is set such that it generates a sustain pulse according to the third exemplary driving waveform.

As shown in FIG. 5, a sustain discharge driving circuit 410 that is formed at, e.g., the scan electrode driver 400 may have an output terminal OUT coupled to the plurality of Y electrodes Y1-Yn. The plurality of X electrodes X1-Xn may be coupled to a ground terminal GND for supplying a ground voltage 0 V, and accordingly, during a sustain period, the ground voltage 0 V may be applied to the X electrodes X1-Xn.

In the accompanying Figures, to aid in understanding and to help simplify the description of the exemplary embodiments, one X and one Y electrode are illustrated, and capacitive components formed between the X and Y electrodes are illustrated as a panel capacitor Cp.

The sustain discharge driving circuit 410 may include transistors Yp1, Yp2, Yn1, Yn2, Yr, Yf, Yh, and Yl, capacitors Cst1 and Cst2, an inductor L, and diodes D1, D2, D3, and D4.

The transistors Yp1, Yp2, Yn1, Yn2, Yr, Yf, Yh, and Yl may control a current path by performing a switching function, and the capacitors Cst1 and Cst2 may perform a power source function, that is, a charging power source function. The transistors Yr and Yf and the diodes D3 and D4 may form a path separator for separating a path along which a current charged through the inductor L to the Y electrode flows from a path along which a current discharged from the Y electrode and passed through the inductor L flows.

It is but one example that the transistors Yp1, Yp2, Yn1, Yn2, Yr, Yf, Yh, and Yl are illustrated as n-channel field effect transistors, particularly NMOS (n-channel metal oxide semiconductor) transistors. These transistors Yp1, Yp2, Yn1, Yn2, Yr, Yf, Yh, and Yl may have a body diode formed in a direction of a drain from a source. These transistors Yp1, Yp2, Yn1, Yn2, Yr, Yf, Yh, and Yl may be formed by other transistors having similar functions. In addition, it is but one example that the transistors Yp1, Yp2, Yn1, Yn2, Yr, Yf, Yh, and Yl are separately formed. These transistors Yp1, Yp2, Yn1, Yn2, Yr, Yf, Yh, and Yl may be formed by a plurality of transistors coupled in parallel.

A drain of the transistor Yp1 may be coupled to a power source Vs/2 for supplying a voltage Vs/2, and a source of the transistor Yp1 may be coupled to a drain of the transistor Yp2. A source of the transistor Yn1 may be coupled to a power source −Vs/2 for supplying a voltage −Vs/2, and a drain of the transistor Yn1 may be coupled to a source of the transistor Yn2. In addition, a source of the transistor Yp2 and a drain of the transistor Yn2 may be coupled to each other, and a node between the source of the transistor Yp2 and the drain of the transistor Yn2 may be coupled to the ground terminal GND having the voltage of 0 V corresponding to half of the voltages Vs/2 and −Vs/2.

A first terminal of the capacitor Cst1 may be coupled to a power source Vs/2, and a second terminal thereof may be coupled to a drain of the transistor Yp2. In addition, a first terminal of the capacitor Cst2 may be coupled to a drain of the transistor Yn1, and a second terminal thereof may be coupled to a power source −Vs/2. An anode of the diode D1 may be coupled to a power source Vs/2, and a cathode thereof may be coupled to the first terminal of the capacitor Cst1. In addition, a cathode of the diode D2 may be coupled to a power source −Vs/2, and an anode thereof may be coupled to a second terminal of the capacitor Cst2.

At this time, the diodes D1 and D2 respectively form a charging path for charging the capacitors Cst1 and Cst2 at the voltage Vs/2 when the respective transistors Yp2 and Yn2 are turned on. Other elements, e.g., transistors, that are capable of forming a charging path may replace the diodes D1 and D2. In FIG. 5, it is assumed that this charging path may charge the respective capacitors Cst1 and Cst2 at the voltage Vs/2.

The ground terminal GND may be coupled to a node between a drain of the transistor Yr and a source of the transistor Yf, and a node between a source of the transistor Yr and a drain of the transistor Yf may be coupled to the first terminal of the inductor L. An anode of the diode D3 may be coupled to a source of the transistor Yr, and a cathode thereof may be coupled to the first terminal of the inductor L. In addition, a cathode of the diode D4 may be coupled to the drain of the transistor Yf, and an anode thereof may be coupled to the first terminal of the inductor L.

At this time, the diode D3 may block a current path formed due to a body diode of the transistor Yr and may form a rising path in which a voltage of the Y electrode may be increased. The diode D4 may block a current path formed due to a body diode of the transistor Yf and may form a falling path in which a voltage of the Y electrode may be decreased.

It is one example that one inductor L may be coupled to a node between the diodes D3 and D4 in FIG. 5. The inductor L may be coupled to the respective rising and falling paths.

A drain of the transistor Yh may be coupled to a power source Vs/2, and a source thereof may be coupled to the Y electrode of the panel capacitor Cp. In addition, a source of the transistor Yl may be coupled to a power source −Vs/2 and a drain thereof may be coupled to the Y electrode of the panel capacitor Cp.

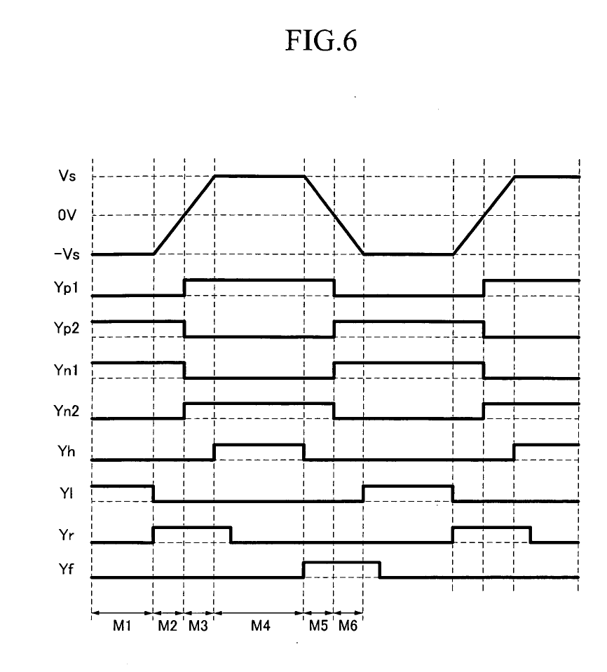

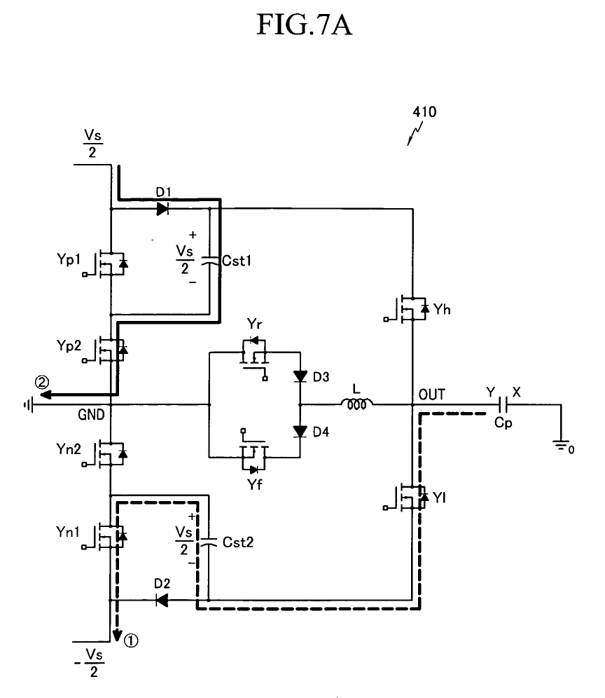

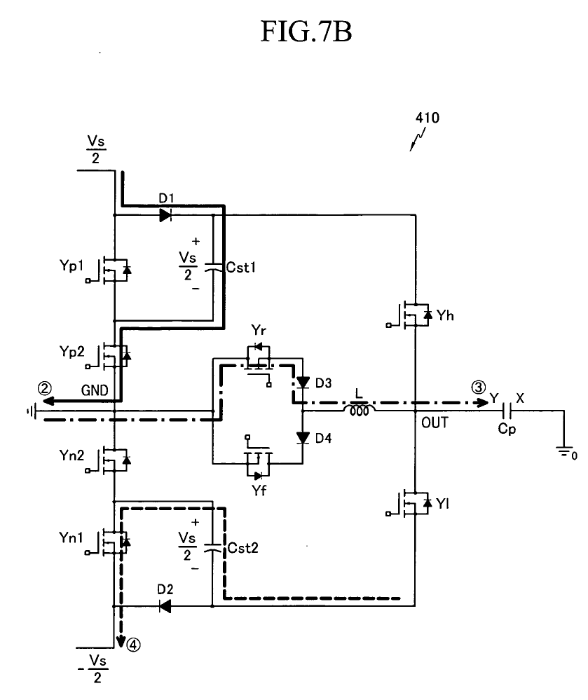

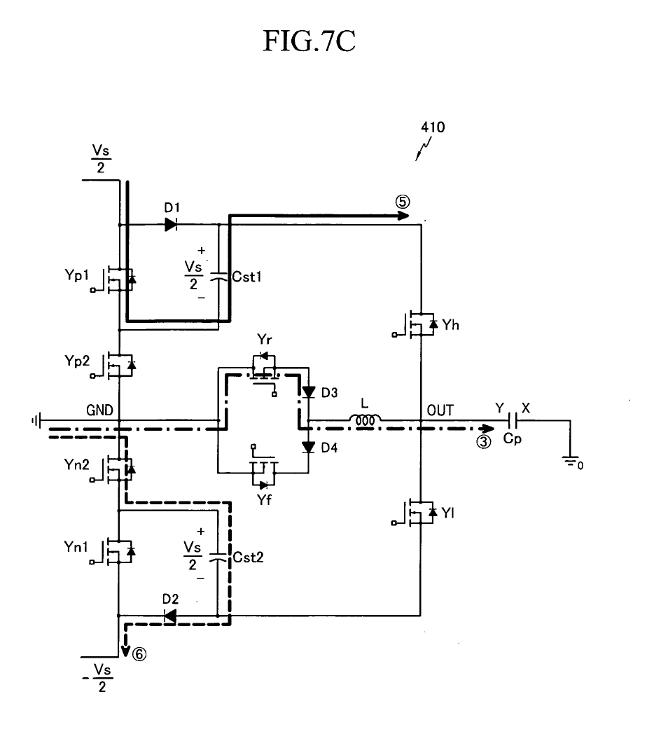

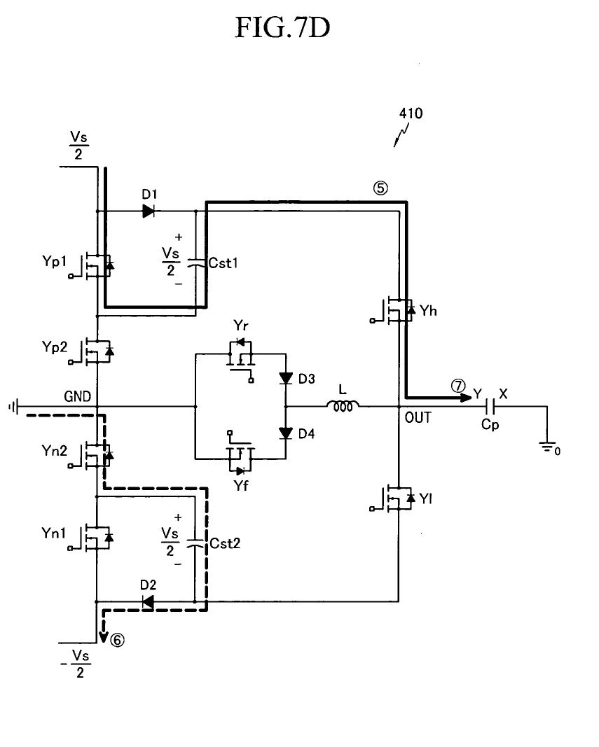

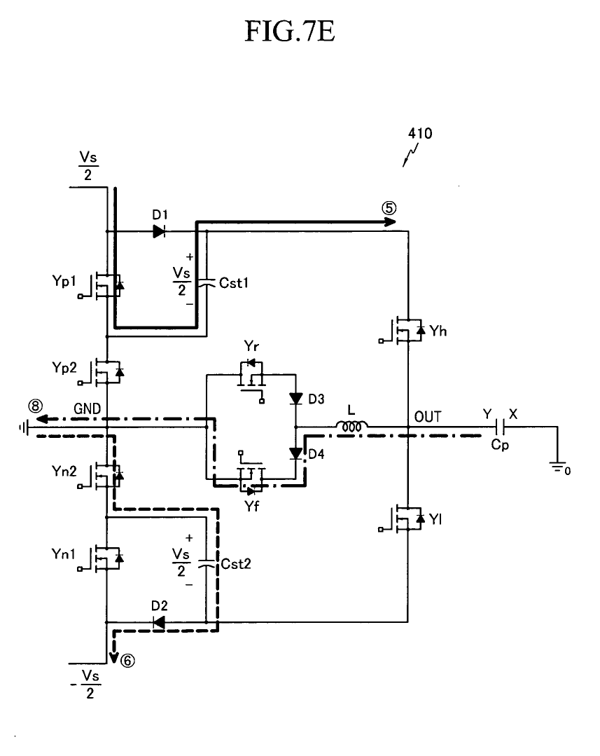

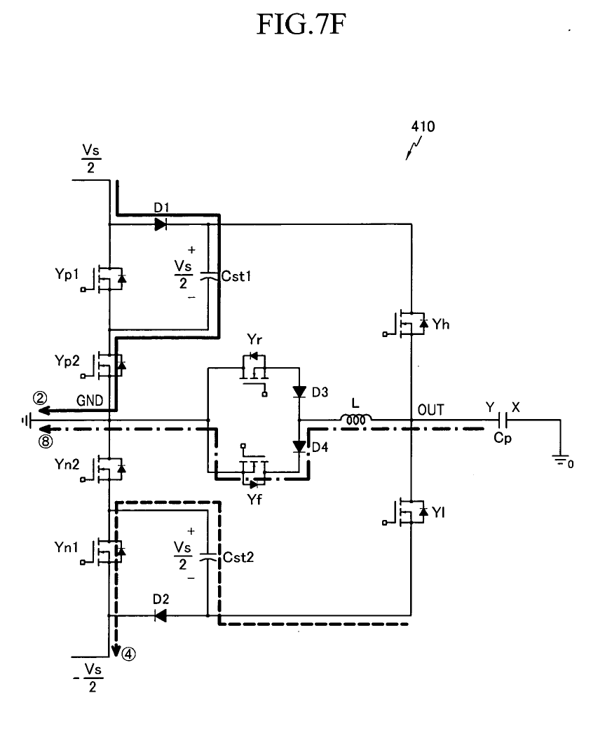

Next, operation of the sustain discharge driving circuit 410 for generating a sustain pulse according to the third driving waveform is described in detail with reference to FIG. 6 and FIG. 7A to FIG. 7F.

FIG. 6 shows an exemplary timing diagram employable by the first exemplary embodiment of a sustain discharge driving circuit shown in FIG. 5, and FIGS. 7A to 7F respectively show current paths corresponding to respective operation modes of the first exemplary embodiment of the sustain discharge driving circuit shown in FIG. 5.

In the following description, it is assumed that the transistors Yp1, Yn2, Yh, and Yl are turned off and the transistors Yp2 and Yn1 are turned on before a first mode M1 starts.

During the first mode M1, the transistor Yl may be turned on, and as shown in FIG. 7A, a first current path \textcircled{1} may be formed through the Y electrode of the panel capacitor Cp, the transistor Yl, the capacitor Cst2, the transistor Yn1, and the power source −Vs/2. Accordingly, during the first mode M1, the voltage −Vs may be applied to the Y electrode. That is, the Y electrode may be applied with the voltage −Vs that is lower than the power source voltage −Vs/2 by as much as the voltage Vs/2 charged at the capacitor Cst2.

Since the transistor Yp1 may be turned off and the transistor Yp2 may be turned on, a second current path \textcircled{2} may be formed through the power source Vs/2, the diode D1, the capacitor Cst1, the transistor Yp2, and the ground terminal GND, and accordingly, the voltage Vs/2 corresponding to a difference between the respective voltages Vs/2 and 0 V of the power source Vs/2 and the ground terminal GND may be charged at the capacitor Cst1.

At this time, the voltage −Vs may be applied to the source of the transistor Yh through the first current path \textcircled{1} and the voltage Vs/2 may be applied to the drain of the transistor Yh through the second current path \textcircled{2}, and accordingly, the voltage 3Vs/2 may be formed between the source and drain of the transistor Yh. Thus, the transistor Yh may be a transistor having a withstand voltage of 3Vs/2. Because a voltage of the source of the transistor Yp1 may be 0 V and the voltage of the drain of the transistor Yp1 may be the voltage Vs/2, the transistor Yp1 may be a transistor having a withstand voltage Vs/2. In addition, because a voltage of the drain of the transistor Yn2 may be 0 V and the voltage of the source of the transistor Yn2 may be the voltage −Vs/2, the transistor Yp1 may be a transistor having a withstand voltage Vs/2.

During a second mode M2, the transistor Yr may be turned on, and a third current path \textcircled{3} may be formed through the ground terminal GND, the transistor Yr, the diode D3, the inductor L, and the Y electrode of the panel capacitor Cp as shown in FIG. 7B. The inductor L and the panel capacitor Cp of the third current path \textcircled{3} may generate an LC resonance. At this time, because the 0 V voltage of the ground terminal GND may be applied to the first terminal of the inductor L and the voltage −Vs may be applied to the second terminal thereof, a voltage of the Y electrode of the panel capacitor Cp may be increased from the voltage −Vs to the voltage Vs by the LC resonance. However, if the voltage of the Y electrode is greater than the drain voltage of Vs/2 of the transistor Yh, current may flow though the body diode of the transistor Yh. Thus, the drain voltage of the transistor Yh may be changed, i.e., increased, to the voltage Vs during a third mode M3 before the voltage of the Y electrode is increased to the voltage Vs/2. Referring to the exemplary timing diagram illustrated in FIG. 6, the voltage of the Y electrode may be increased to 0 V during the second mode M2.

Because the transistor Yn1 may be turned on and the transistor Yl may be turned off during the second mode M2, a fourth current path \textcircled{4} may be formed through the transistor Yn1, the power source −Vs/2, and the capacitor Cst2. The fourth current path \textcircled{4} may apply the voltage −Vs to the source of the transistor Yl. Accordingly, the fourth current path \textcircled{4} may prevent current from flowing though the body diode of the transistor Yl from the Y electrode.

During the third mode M3, the transistor Yp1 may be turned on and the transistor Yp2 may be turned off. Then, as shown in FIG. 7C, a fifth current path \textcircled{5} may be formed through the power source Vs/2, the transistor Yp1, and the capacitor Cst1, and the drain of the transistor Yh may be applied with the voltage Vs. Accordingly, although the voltage of the Y electrode may be increased to the voltage Vs by the third current path \textcircled{3} in which the LC resonance may be generated, the current may not flow through the body diode of the transistor Yh.

Because the transistor Yn1 may be turned off and the transistor Yn2 may be turned on during the third mode M3, a sixth current path \textcircled{6} may be formed through the ground terminal GND, the transistor Yn2, the capacitor Cst2, the diode D2, and the power source −Vs/2. The sixth current path \textcircled{6} may charge the voltage Vs/2 corresponding to a difference between the respective 0 V and −Vs/2 voltages of the ground terminal GND and the power source −Vs/2 at the capacitor Cst2.

Then, referring to FIG. 7D, during a fourth mode M4, the transistor Yh may be turned on, and accordingly, a seventh current path \textcircled{7} may be formed through the power source Vs/2, the transistor Yp1, the capacitor Cst1, the transistor Yh, and the Y electrode of the panel capacitor Cp. The seventh current path \textcircled{7} may apply the voltage Vs to the Y electrode. That is, a voltage, e.g., the voltage Vs that may be higher than the power source voltage Vs/2 by as much as the voltage Vs/2 charged at the capacitor Cst1, may be applied to the Y electrode.

Because the sixth current path \textcircled{6} may apply the voltage −Vs/2 to the source of the transistor Yl and the seventh current path \textcircled{7} may apply the voltage Vs to the drain of the transistor Yl, and the voltage 3Vs/2 may be formed between the source and the drain of the transistor Yl. Accordingly, the transistor Yl may be a transistor having a withstand voltage of 3Vs/2.

Because the source voltage of the transistor Yp2 may be 0 V and the drain voltage of the transistor Yp2 may be the voltage Vs/2, the transistor Yp2 may be a transistor having a withstand voltage Vs/2. In addition, because the drain voltage of the transistor Yn1 may be 0 V and the source voltage of the transistor Yn1 may be the voltage −Vs/2, the transistor Yn1 may be a transistor having a withstand voltage Vs/2.

Referring to FIG. 7E, during a fifth mode M5, the transistor Yf may be turned on, and accordingly, an eighth current path \textcircled{8} may be formed though the Y electrode of the panel capacitor Cp, the inductor L, the diode D4, the transistor Yf, and the ground terminal GND. The inductor L and the panel capacitor Cp of the eighth current path \textcircled{8} may generate a resonance. The energy stored at the panel capacitor Cp may be recovered though the inductor L into the ground terminal GND, and the voltage of the Y electrode may be decreased from the voltage Vs to the voltage −Vs.

However, because current may flow through the body diode of the transistor Yl when the voltage of the Y electrode is smaller than the voltage −Vs/2 of the source of the transistor Yl applied by the sixth current path \textcircled{6}, the source voltage of the transistor Yl may be changed to the voltage −Vs during a sixth mode M6 before the voltage of the Y electrode is decreased to the voltage −Vs/2.

FIG. 6 illustrates driving timing that is switched such that the voltage of the Y electrode is decreased to 0 V during the fifth mode M5. The transistor Yh may be turned off, and accordingly the fifth current path \textcircled{5} may be formed and the drain of the transistor Yh may be applied with the voltage Vs. Accordingly, the current path \textcircled{5} may prevent the current from flowing though the body diode of the transistor Yh to the Y electrode.

Referring to FIG. 7F, during a sixth mode M6, the transistor Yn1 may be turned on and the transistor Yn2 may be turned off, and accordingly, the fourth current path \textcircled{4} may be formed though the capacitor Cst2, the transistor Yn1, and the power source −Vs/2. The source of the transistor Yl may be applied with the voltage −Vs. Therefore, although the voltage of the Y electrode may be decreased to the voltage −Vs by means of the eighth current path \textcircled{8}, the current may not flow through the body diode of the transistor Yl.

Since the transistor Yp1 may be turned off and the transistor Yp2 may be turned on, the second current path \textcircled{2} may be formed through the power source Vs/2, the diode D1, the capacitor Cst1, the transistor Yp2, and the power source −Vs/2. The sixth current path \textcircled{6} may charge the voltage Vs/2 corresponding to a difference between the voltages of the ground terminal GND and −Vs/2 at the capacitor Cst2.

As such, during the sustain period of the first exemplary embodiment, the first to sixth modes M1 to M6 may be repeated a predetermined number of times corresponding to a weight value of the corresponding subfield, and accordingly, the Y electrode may be alternately applied with the voltages Vs and −Vs. The transistors Yh and Yl may each be a transistor having a withstand voltage 3Vs/2 corresponding to ¾ of the voltage applied to the Y electrode, and the transistors Yp1, Yp2, Yn1, and Yn2 may each be a transistor having a withstand voltage of Vs/2.

Next, with reference to FIG. 5, a sustain discharge driving circuit for generating a sustain pulse according to the first driving waveform shown in FIG. 2 will be described.

To generate a sustain pulse according to the first driving waveform shown in FIG. 2, a sustain discharge driving circuit similar to the sustain discharge driving circuit 410 of FIG. 5, but with a controlled power source voltage level(s) may be employed. Such a sustain discharge driving circuit having the controlled power source voltage level(s) may be provided at each of the scan electrode driver 400 and the sustain electrode driver 500.

More particularly, the sustain discharge driving circuit for generating a sustain pulse according to the first driving waveform of FIG. 2 may employ the exemplary sustain discharge driving circuit 410 illustrated in FIG. 5, however, e.g., a voltage of the power source coupled to the drain of the transistor Yp1 may be set at a voltage 3Vs/4, the ground terminal GND may be replaced by a voltage source of Vs/2 voltage, and a voltage of the power source coupled to the source of the transistor Yn1 may be set to a voltage Vs/4.

As a result, when the transistors Yp1 and Yn1 are respectively turned off and the transistors Yp2 and Yn2 are respectively turned on, the capacitors Cst1 and Cst2 may be respectively charged at the voltage Vs/4 and the sustain pulse alternately having voltages Vs and 0 may be applied to the Y electrode through the same paths shown in FIGS. 7A to 7F.

A sustain discharge driving circuit for generating a sustain pulse for the second driving waveform shown in FIG. 3 will now be described with reference to FIG. 5.

To generate the sustain pulse according to the second driving waveform shown in FIG. 3, a sustain discharge driving circuit similar to the sustain discharge driving circuit 410 of FIG. 5, but with a controlled power source voltage level(s) may be employed. Such a sustain discharge driving circuit having the controlled power source voltage level(s) may be provided at each of the scan electrode driver 400 and the sustain electrode driver 500.

More particularly, the sustain discharge driving circuit for generating a sustain pulse according to the second driving waveform of FIG. 3 may employ the circuit illustrated in FIG. 5, however, e.g., a voltage of the power source coupled to the drain of the transistor Yp1 may be set as a voltage Vs/4 and a voltage of the power source coupled to the source of the transistor Yn1 may be set as a voltage −Vs/4.

As a result, when the transistors Yp1 and Yn1 are respectively turned off and the transistors Yp2 and Yn2 are respectively turned on, the capacitors Cst1 and Cst2 may be respectively charged at the voltage Vs/4 and the sustain pulse alternately having voltages Vs/2 and −Vs/2 may be applied to the Y electrode through the same paths shown in FIGS. 7A to 7F.

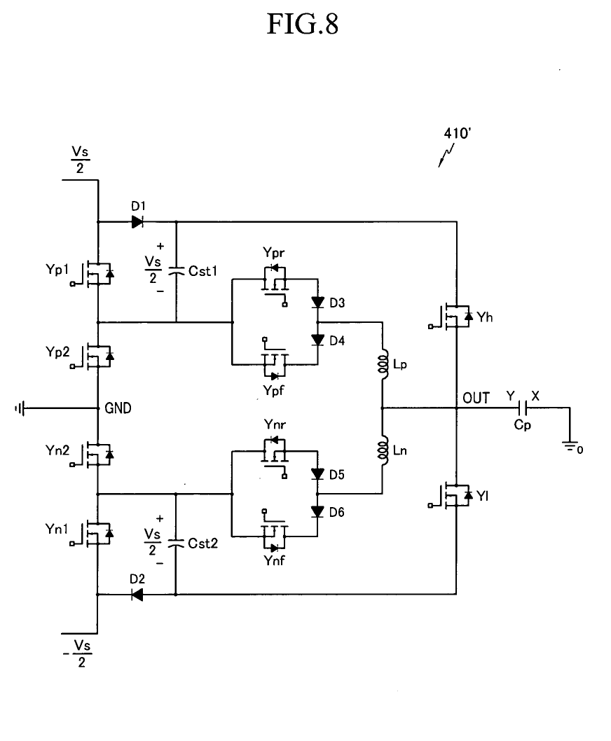

Next, a sustain discharge driving circuit and operation thereof according the second exemplary embodiment of the present invention is described with FIGS. 8, 9 and 10A to 10F. Hereinafter, firstly, how to generate the third driving waveform is described and then how to generate the first and second driving waveforms is described.

The sustain discharge driving circuit according the second exemplary embodiment of the present invention shown in FIG. 8 may have a source voltage level set such that it generates a sustain pulse for the third driving waveform.

As shown in FIG. 8, the sustain discharge driving circuit 410′ may include transistors Yp1, Yp2, Yn1, Yn2, Ypr, Ypf, Ynr, Ynf, Yh, and Yl, the capacitors Cst1 and Cst2, the inductors Lp and Ln, and the diode D1, D2, D3, D4, D5, and D6.

The transistors Yp1, Yp2, Yn1, Yn2, Ypr, Ypf, Ynr, Ynf, Yh, and Yl may control a current path by performing a switch function. The capacitors Cst1 and Cst2 may perform a power source function, e.g., a charging power source function. The transistors Ypr and Ypf and the diodes D3 and D4 may form a first path separator for separating a path along which a current charged through the inductor Lp to the Y electrode may flow from a path along which a current discharged from the Y electrode may pass through the inductor Lp. The transistors Ynr and Ynf and the diodes D5 and D may form a second path separator for separating a path along which a current charged through the inductor Ln to the Y electrode may flow from a path along which a current discharged from the Y electrode may pass through the inductor Ln.

The transistors Yp1, Yp2, Yn1, Yn2, Ypr, Ypf, Ynr, Ynf, Yh, and Yl are illustrated as n-channel field effect transistor, particularly NMOS (n-channel metal oxide semiconductor) transistors. These transistors Yp1, Yp2, Yn1, Yn2, Ypr, Ypf, Ynr, Ynf, Yh, and Yl may have a body diode formed in a direction of a drain from a source. These transistors Yp1, Yp2, Yn1, Yn2, Ypr, Ypf, Ynr, Ynf, Yh, and Yl may be formed by other transistors having similar functions and are not limited to, e.g., NMOS transistors. It is but one example that the transistors Yp1, Yp2, Yn1, Yn2, Ypr, Ypf, Ynr, Ynf, Yh, Yl are separately formed in FIG. 8, and the transistors Yp1, Yp2, Yn1, Yn2, Ypr, Ypf, Ynr, Ynf, Yh, Yl may be formed, e.g., by a plurality of transistors coupled in parallel.

A drain of the transistor Yp1 may be coupled to a power source Vs/2 for supplying a voltage Vs/2, and a source of the transistor Yp1 may be coupled to a drain of the transistor Yp2. A source of the transistor Yn1 may be coupled to a power source −Vs/2 for supplying a voltage −Vs/2 corresponding to half of the low level voltage −Vs, and a drain of the transistor Yn1 is coupled to a source of the transistor Yn2. Further, a source of the transistor Yp2 and a drain of the transistor Yn2 may be coupled to each other, and a node between a source of the transistor Yp2 and a drain of the transistor Yn2 may be coupled to a ground terminal GND corresponding to half of the voltages Vs/2 and −Vs/2.

A first terminal of the capacitor Cst1 may be coupled to the power source Vs/2, and a second terminal thereof may be coupled to the drain of the transistor Yp2. A first terminal of the capacitor Cst2 may be coupled to the drain of the transistor Yn1, and a second terminal thereof may be coupled to the power source −Vs/2. An anode of the diode D1 may be coupled to the power source Vs/2, and a cathode thereof may be coupled to the first terminal of the capacitor Cst1. In addition, a cathode of the diode D2 is coupled to a power source −Vs/2, and an anode thereof may be coupled to a second terminal of the capacitor Cst2.

The diodes D1 and D2 may respectively form charging paths for charging the capacitors Cst1 and Cst2 at the voltage Vs/2 when the transistors Yp2 and Yn2 are respectively turned on. Other elements, e.g., transistors, which may be capable of forming a charging path may replace the diodes D1 and D2. In FIG. 8, it is assumed that these charging paths, e.g., charging paths formed by the diodes D1, D2, charge the respective capacitors Cst1 and Cst2 at the voltage Vs/2.

A drain of the transistor Yh may be coupled to the first terminal of the capacitor Cst1, a source of the transistor Yl may be coupled to the second terminal of the capacitor Cst2. A source of the transistor Yh and a drain of the transistor Yl may be respectively coupled to a Y electrode of the panel capacitor Cp.

A drain of the transistor Ypr and a source of the transistor Ypf may be respectively coupled to the second terminal of the capacitor Cst1. A drain of the transistor Ynr and a source of the transistor Ynf may be respectively coupled to the first terminal of the capacitor Cst2.

A node between a source of the transistor Ypr and a drain of the transistor Ypf may be coupled to a first terminal of the inductor Lp. A node between a source of the transistor Ynr and a drain of the transistor Ynf may be coupled to a first terminal of the inductor Ln. Second terminals of the inductors Lp and Ln may be respectively coupled to the Y electrode of the panel capacitor Cp.

An anode of the diode D3 may be coupled to the source of the transistor Ypr, and a cathode thereof may be coupled to the first terminal of the inductor Lp. A cathode of the diode D4 may be coupled to the drain of the transistor Ypf, and an anode thereof may be coupled to the first terminal of the inductor Lp. An anode of the diode D5 may be coupled to the source of the transistor Ynr, and a cathode thereof may be coupled to the first terminal of the inductor Ln. A cathode of the diode D6 may be coupled to the drain of the transistor Ynf and an anode thereof may be coupled to the first terminal of the inductor Ln.

The diodes D3 and D5 may block a current path formed due to body diodes of the transistors Ypr and Ynr, and may form a rising path by which a voltage of the Y electrode may be increased. The diodes D4 and D6 may block a current path formed due to body diodes of the transistors Ypf and Ynf, and may form a falling path along which the voltage of the Y electrode may be decreased.

It is but one example that the inductors Lp and Ln may be respectively coupled to respective rising and falling paths of the exemplary sustain discharge circuit shown in FIG. 8. As an alternative, e.g., only one inductor may be coupled at an overlapping part of the rising and falling paths, i.e., one inductor may be connected so as to play a role along both the rising paths and the falling paths.

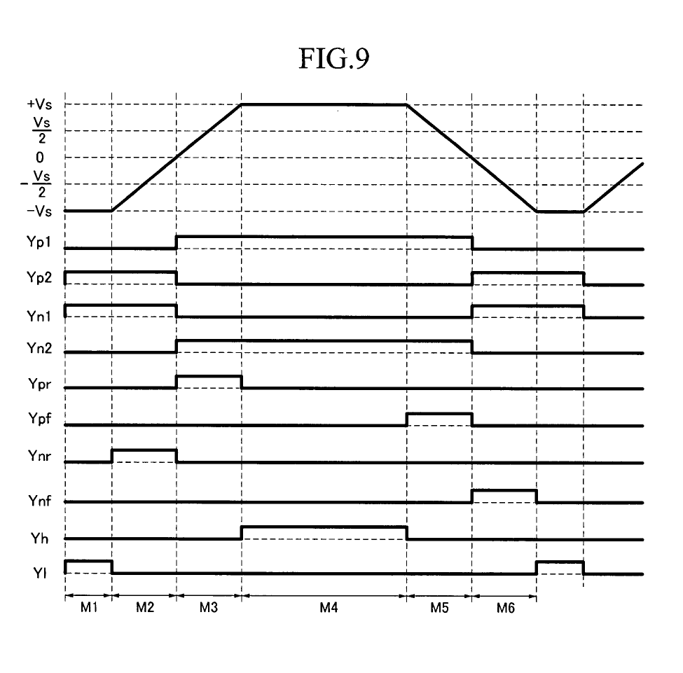

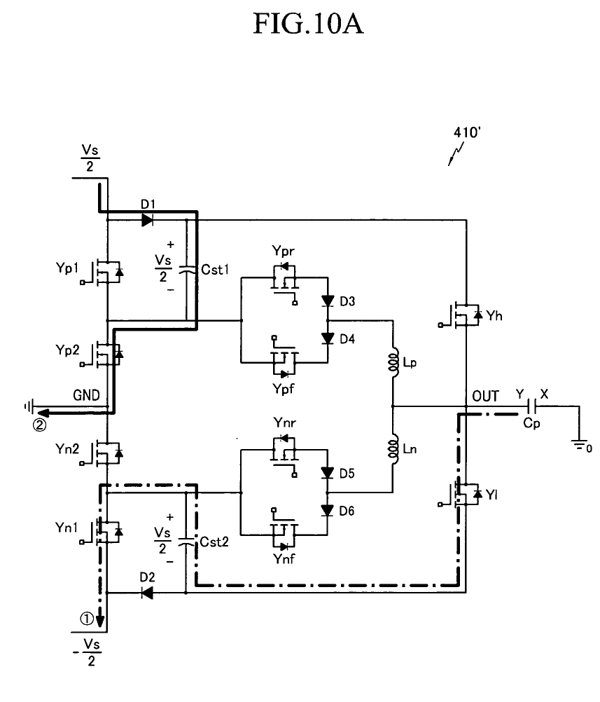

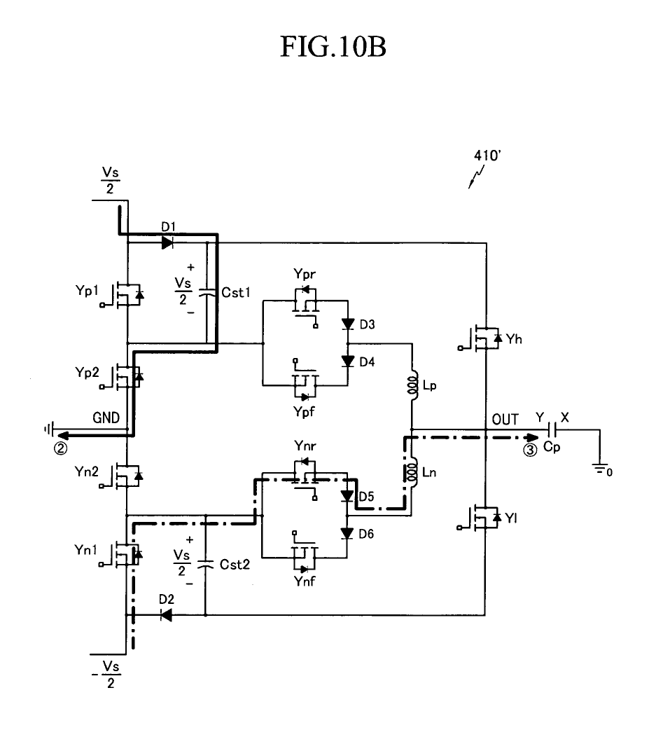

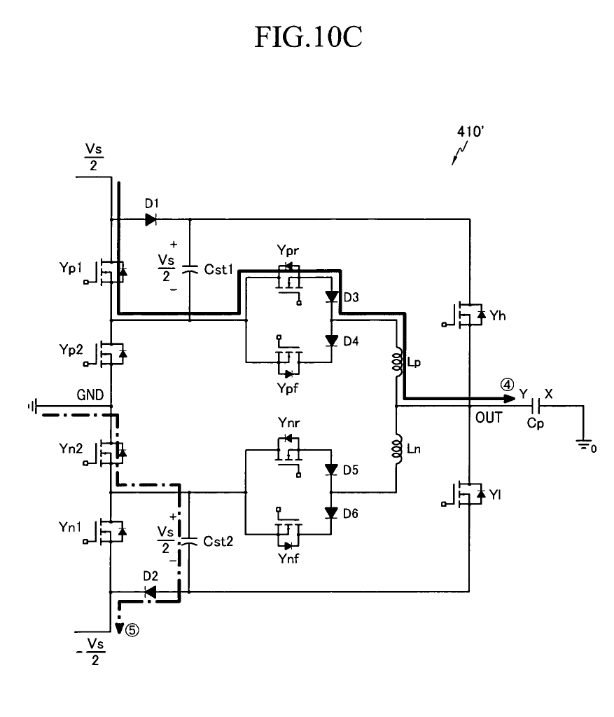

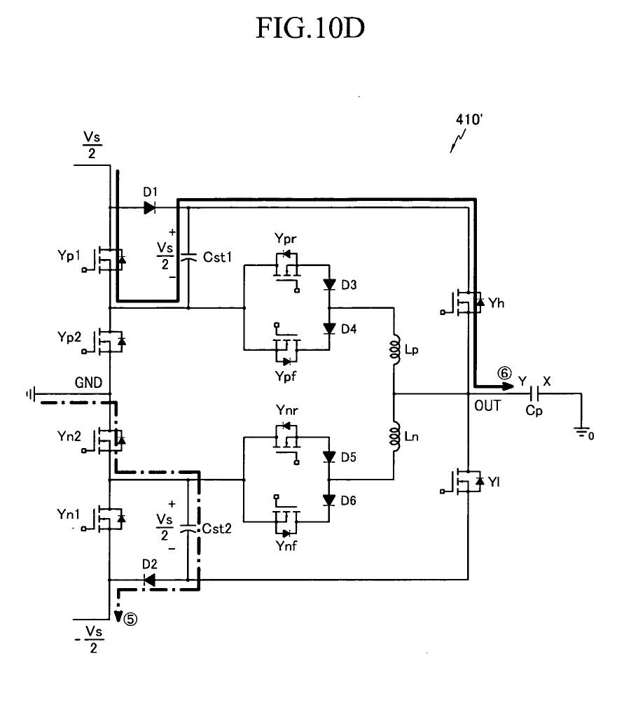

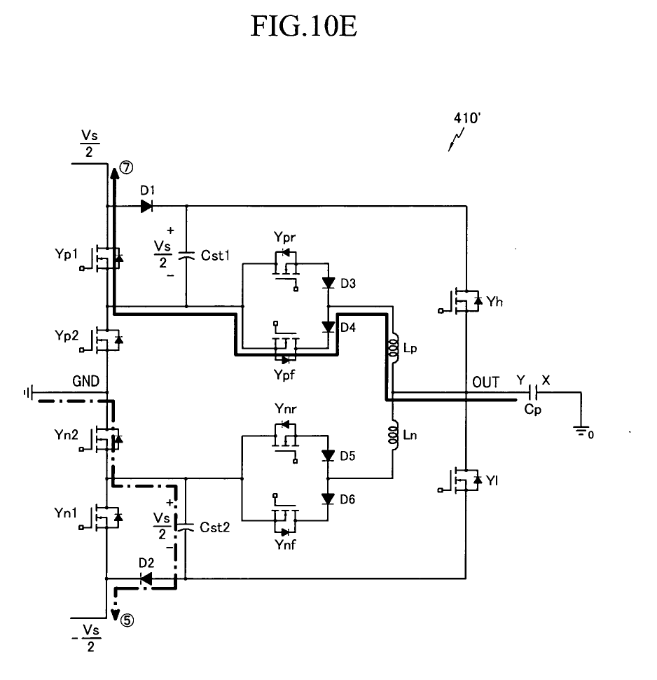

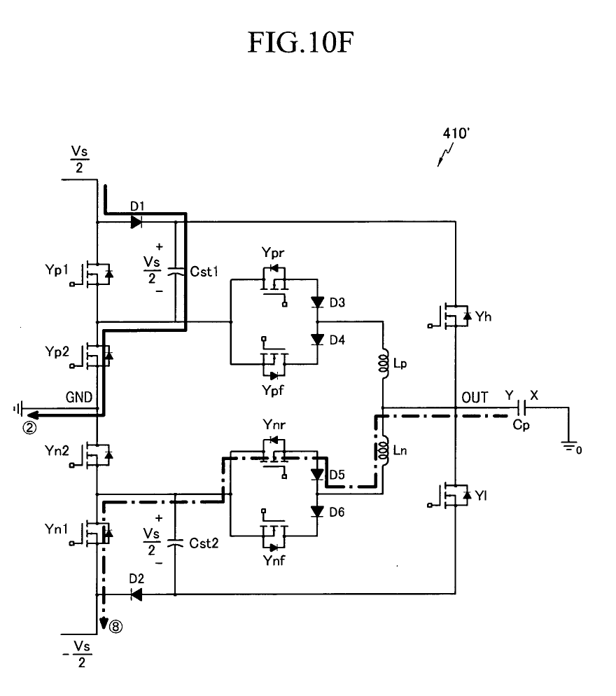

Next, an exemplary operation of the sustain discharge driving circuit 410′ for generating a sustain pulse according to the third exemplary driving waveform is described in detail with reference to FIGS. 9, and 10A to 10F.

FIG. 9 shows a driving timing of the sustain discharge driving circuit according to a second exemplary embodiment of the present invention. FIG. 10A to FIG. 10F respectively show a current path at the respective operation modes of a sustain discharge driving circuit according to a second exemplary embodiment of the present invention.

In the following description, it is assumed that the transistors Yp2, Yn1, and Yn1 are turned on before a first mode M1 starts.

During the first mode M1, the transistor Yn1 may be turned off and the transistor Yl may be turned on. As shown in FIG. 10A, a first current path \textcircled{1} may be formed through the Y electrode of the panel capacitor Cp, the capacitor Cst2, the transistor Yn1, and the power source −Vs/2, and accordingly, the voltage −Vs may be applied to the Y electrode through the current path \textcircled{1}. That is, e.g., the Y electrode may be applied with the voltage −Vs that is lower than the power source voltage −Vs/2 by as much as the voltage Vs/2 charged at the capacitor Cst2.

Because the transistor Yp1 may be turned off and the transistor Yp2 may be turned on during the mode 1 M1, a second current path \textcircled{2} may be formed through the power source Vs/2, the diode D1, the capacitor Cst1, the transistor Yp2, and the power source 0 V, and accordingly, by the second current path \textcircled{2}, the voltage Vs/2 corresponding to a difference between the Vs/2 and 0 V voltages of the Vs/2 power source and the ground terminal GND may be charged at the capacitor Cst1.

As a result of the first current path \textcircled{1}, the source of the transistor Yh may have the voltage −Vs, and as a result of the second current path \textcircled{2}, the drain of the transistor Yh may have the voltage Vs/2. Accordingly, a voltage 3Vs/2 may be formed between the source and drain of the transistor Yh. Thus, the transistor Yh may be a transistor having a withstand voltage of 3Vs/2.

Because the voltage of the source of the transistor Yp1 may be 0 V and the voltage of the drain of the transistor Yp1 may be the voltage Vs/2, the transistor Yp1 may be a transistor having a withstand voltage Vs/2. Because the voltage of the drain of the transistor Yn2 may be 0 V and the voltage of the source of the transistor Yn2 may be the voltage −Vs/2, the transistor Yp1 may be a transistor having a withstand voltage Vs/2.

Referring to FIG. 10B, during a second mode M2, the transistor Yl may be turned off and the transistor Ynr may be turned on. A third current path \textcircled{3} may be formed through the power source −Vs/2, the transistor Yn1, the transistor Ynr, the diode D5, the inductor Ln, and the Y electrode of the panel capacitor Cp. The inductor Ln and the panel capacitor Cp of the third current path \textcircled{3} may generate an LC resonance. Accordingly, the voltage of the Y electrode of the panel capacitor Cp may be increased from the voltage −Vs to 0 V.

Referring to FIG. 10C, during a third mode M3, the transistors Ynr and Yp2 may be turned off and the transistors Ypr and Yp1 may be turned on, and a fourth current path \textcircled{4} may be continuously formed through the power source Vs/2, the transistor Yp1, the transistor Ypr, the diode D3, the inductor Lp, and the Y electrode of the panel capacitor Cp. The inductor Lp and the panel capacitor Cp of the fourth current path \textcircled{4} may generate an LC resonance. Accordingly, the voltage of the Y electrode of the panel capacitor Cp may be increased from the voltage 0 V to the voltage Vs.

As shown in FIG. 10C, the transistor Yn1 may be turned off and the transistor Yn2 may be turned on during the third mode M3, and thus, a fifth current path \textcircled{5} may be formed through the ground terminal GND, the transistor Yn2, the capacitor Cst2, the diode D2, and the power source Vs/2. The fifth current path \textcircled{5} may charge the voltage Vs/2 corresponding to a difference between the voltages of the ground terminal GND and the power source Vs at the capacitor Cst2.

Referring to FIG. 10D, during a fourth mode M4, the transistor Ypr may be turned off and the transistor Yh may be turned on, and thus, a sixth current path \textcircled{6} may be formed through the power source Vs/2, the transistor Yp1, the capacitor Cst1, the transistor Yh, and the Y electrode of the panel capacitor Cp. The sixth current path \textcircled{6} may apply the voltage Vs to the Y electrode. That is, the voltage Vs that is higher than the power source voltage Vs/2 by, e.g., as much as the voltage Vs/2 charged at the capacitor Cst1, may be applied to the Y electrode.

Because the fifth current path \textcircled{5} may apply the voltage −Vs/2 to the source of the transistor Yl and the sixth current path \textcircled{6} may apply the voltage Vs to the drain of the transistor Yl, the voltage 3Vs/2 may be formed between the source and the drain of the transistor Yl. Accordingly, the transistor Yl may be a transistor having a withstand voltage of 3Vs/2.

Because the source voltage of the transistor Yp2 may be 0 V and the drain voltage of the transistor Yp2 may be the voltage Vs/2, the transistor Yp2 may be a transistor having a withstand voltage Vs/2. In addition, because the drain voltage of the transistor Yn1 may be 0 V and the source voltage of the transistor Yn1 may be the voltage −Vs/2, the transistor Yn1 may be a transistor having a withstand voltage Vs/2.

Referring to FIG. 10E, during a fifth mode M5, the transistor Yh may be turned off and the transistor Ypf may be turned on, and thus, a seventh current path \textcircled{7} may be formed though the Y electrode of the panel capacitor Cp, the inductor Lp, the diode D4, the transistor Yf, and the transistor Yp1, and the power source Vs/2. The inductor Lp and the panel capacitor Cp of the seventh current path \textcircled{7} may generate an LC resonance. Then, energy stored at the panel capacitor Cp may be recovered though current flowing through the inductor Lp into the ground terminal GND, and the voltage of the Y electrode may be decreased from the voltage Vs to 0 V.

Referring to FIG. 10F, during a sixth mode M6, the transistors Ypf and Yn2 may be turned off and the transistors Ynf and Yn1 may be turned on, and thus, an eighth current path \textcircled{8} may be formed though the Y electrode of the panel capacitor Cp, the inductor Ln, the diode D4, the transistor Ynf, and transistor Yn1, and the power source −Vs/2. The inductor Ln and the panel capacitor Cp of the eighth current path \textcircled{8} may generate an LC resonance. Accordingly, the voltage of the Y electrode of the panel capacitor Cp may be decreased from 0 V to the voltage −Vs.

Because the transistor Yp1 may be turned off and the transistor Yp2 may be turned on during the sixth mode M6, the second current path \textcircled{2} may be formed, as shown in FIG. 10F. Thus, the capacitor Cst1 may charge the voltage Vs/2 corresponding to a difference between the 0 V and Vs/2 voltages of the ground terminal GND and the Vs/2 power source.

As such, during such a sustain period, the first through sixth modes M1 to M6 may be repeated a predetermined number of times corresponding to a weight value of the corresponding subfield, and accordingly, the Y electrode may be alternately applied with the voltages Vs and −Vs. The transistors Yh and Yl may be a transistor having a withstand voltage 3Vs/2 corresponding to ¾ of the voltage applied to the Y electrode, and the transistors Yp1, Yp2, Yn1, and Yn2 may be a transistor having a withstand voltage Vs/2.

Next, with reference to FIG. 8, a sustain discharge driving circuit for generating a sustain pulse according to the first driving waveform shown in FIG. 2 will be described.

To generate a sustain pulse according to the first driving waveform shown in FIG. 2, a sustain discharge driving circuit similar to the sustain discharge circuit 410′ of FIG. 8, but with a controlled power source voltage level(s) may be employed. Such a sustain discharge driving circuit having the controlled power source voltage level may be provided at each of the scan electrode driver and the sustain electrode driver 500.

More particularly, the sustain discharge driving circuit for generating a sustain pulse according to the first driving waveform of FIG. 2 may employ the exemplary sustain discharge driving circuit 410′ illustrated in FIG. 8, however, e.g., a voltage of the power source coupled to the drain of the transistor Yp1 may be set as a voltage of 3Vs/4, the ground terminal GND may be replaced by a voltage source of Vs/2 voltage, and a voltage of the power source coupled to the source of the transistor Yn1 may be set to a voltage Vs/4.

As a result, when the transistors Yp1 and Yn1 are respectively turned off and the transistors Yp2 and Yn2 are respectively turned on, the capacitors Cst1 and Cst2 may be respectively charged at the voltage Vs/4 and the sustain pulse alternately having voltages Vs and 0 may be applied to the Y electrode through the same paths shown in FIGS. 10A to 10F.

A sustain discharge driving circuit for generating a sustain pulse for the second driving waveform shown in FIG. 3 will be described with reference to FIG. 8.

A sustain discharge driving circuit similar to the sustain discharge circuit 410′ of FIG. 8, but with a controlled power source voltage level(s) may be employed. Such a sustain discharge driving circuit having the controlled power source voltage level(s) may be provided at each of the scan electrode driver 400 and the sustain electrode driver 500.

More particularly, the sustain discharge driving circuit for generating a sustain pulse according to the second driving waveform of FIG. 3 may employ the circuit illustrated in FIG. 8, however, e.g., a voltage of the power source coupled to the drain of the transistor Yp1 may be set to a voltage Vs/4 and a voltage of the power source coupled to the source of the transistor Yn1 may be set to a voltage −Vs/4.

As a result, when the transistors Yp1 and Yn1 are respectively turned off and the transistors Yp2 and Yn2 are respectively turned on, the capacitors Cst1 and Cst2 may be respectively charged at the voltage Vs/4 and the sustain pulse alternately having voltages Vs/2 and −Vs/2 may be applied to the Y electrode through the same paths shown in FIGS. 10A to 10F.

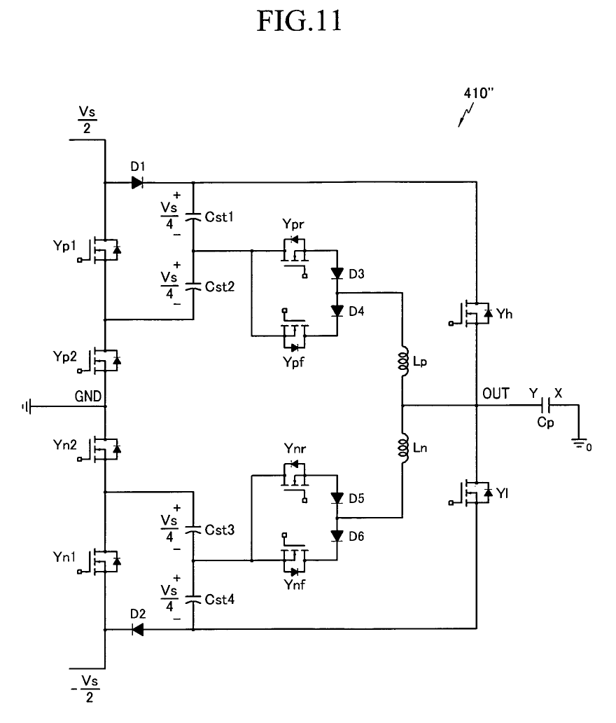

A sustain discharge driving circuit 410″ and operation thereof according the third exemplary embodiment of the present invention is described with FIGS. 11, 12, and 13A to 13J. Hereinafter, generation of the third driving waveform illustrated in FIG. 4 will be described first, and then, generation of the first and second driving waveforms using the sustain discharge driving circuit 410″ will be described.

The sustain discharge driving circuit 410″ according the second exemplary embodiment of the present invention shown in FIG. 11 may have a source voltage level(s) set such that it generates a sustain pulse for the third driving waveform shown in FIG. 4.

As shown in FIG. 11, the sustain discharge driving circuit 410′ may include transistors Yp1, Yp2, Yn1, Yn2, Ypr, Ypf, Ynr, Ynf, Yh, and Yl, the capacitors Cst1, Cst2, Cst3, and Cst4, the inductors Lp and Ln, and the diodes D1, D2, D3, D4, D5, and D6.

The transistors Yp1, Yp2, Yn1, Yn2, Ypr, Ypf, Ynr, Ynf, Yh, and Yl may control a current path by performing a switch function. The capacitor Cst1, Cst2, Cst3, and Cst4 may perform a power source function, e.g., a charging power source function. The transistors Ypr and Ypf and the diodes D3 and D4 may form a first path separator for separating a path along which a current charged through the inductor Lp to the Y electrode may flow from a path along which a current discharged from the Y electrode may pass through the inductor Lp. In addition, the transistors Ynr and Ynf and the diodes D5 and D may form a first path separator for separating a path along which a current charged through the inductor Ln to the Y electrode may flow from a path along which a current discharged from the Y electrode may pass through the inductor Ln.

The transistors Yp1, Yp2, Yn1, Yn2, Ypr, Ypf, Ynr, Ynf, Yh, and Yl are illustrated as n-channel field effect transistors, particularly NMOS (n-channel metal oxide semiconductor) transistors. These transistors Yp1, Yp2, Yn1, Yn2, Ypr, Ypf, Ynr, Ynf, Yh, and Yl may have a body diode formed in a direction of a drain from a source. These transistors Yp1, Yp2, Yn1, Yn2, Ypr, Ypf, Ynr, Ynf, Yh, and Yl may be formed by other transistors having similar functions, and thus, are not limited to NMOS transistors. It is but one example that the transistors Yp1, Yp2, Yn1, Yn2, Ypr, Ypf, Ynr, Ynf, Yh, and Yl are separately formed in FIG. 11, and the transistors Yp1, Yp2, Yn1, Yn2, Ypr, Ypf, Ynr, Ynf, Yh, and Yl may be, e.g., formed by a plurality of transistors coupled in parallel.

A drain of the transistor Yp1 may be coupled to a power source Vs/2 for supplying a voltage Vs/2, and a source of the transistor Yp1 may be coupled to a drain of the transistor Yp2. A source of the transistor Yn1 may be coupled to a power source −Vs/2 for supplying a voltage −Vs/2 corresponding to half of the low level voltage −Vs, and a drain of the transistor Yn1 may be coupled to a source of the transistor Yn2. Further, a source of the transistor Yp2 and a drain of the transistor Yn2 may be coupled each other, and a node between the source of the transistor Yp2 and the drain of the transistor Yn2 may be coupled to the ground terminal GND corresponding to half of the voltages Vs/2 and −Vs/2.

A first terminal of the capacitor Cst1 may be coupled to the power source Vs/2, and a second terminal thereof may be coupled to a first terminal of the capacitor Cst2. A second terminal of the capacitor Cst2 may be coupled to the drain of the transistor Yp2. A first terminal of the capacitor Cst3 may be coupled to the drain of the transistor Yn1, and a second terminal thereof may be coupled to a first terminal of the capacitor Cst4. A second terminal of the capacitor Cst4 may be coupled to the power source −Vs/2. An anode of the diode D1 may be coupled to the power source Vs/2 and a cathode thereof may be coupled to the first terminal of the capacitor Cst1. A cathode of the diode D2 may be coupled to the power source −Vs/2, and an anode thereof may be coupled to the second terminal of the capacitor Cst2.

At this time, the diodes D1 and D2 may respectively form a charging path for charging the capacitors Cst1 and Cst2 at the voltage Vs/2 when the transistors Yp2 and Yn2 are respectively turned on. Other elements, e.g., transistors, that are capable of forming a charging path may replace the diodes D1 and D2. In FIG. 11, it is assumed that these charging paths, e.g., charging paths formed by the diodes D1, D2, charge the respective capacitors Cst1 and Cst2 at the voltage Vs/2.

A drain of the transistor Yh may be coupled to the first terminal of the capacitor Cst1, a source of the transistor Yl may be coupled to the second terminal of the capacitor Cst2, and a source of the transistor Yh and a drain of the transistor Yl may be respectively coupled to a Y electrode of the panel capacitor Cp.

A drain of the transistor Ypr and a source of the transistor Ypf may be respectively coupled to a node between the second terminal of the capacitor Cst1 and the first terminal of the capacitor Cst2, and a drain of the transistor Ynr and a source of the transistor Ynf may be respectively coupled to a node between the second terminal of the capacitor Cst3 and the first terminal of the capacitor Cst4.

A node between a source of the transistor Ypr and a drain of the transistor Ypf may be coupled to a first terminal of the inductor Lp, and a node between a source of the transistor Ynr and a drain of the transistor Ynf may be coupled to a first terminal of the inductor Ln. Second terminals of the inductors Lp and Ln may be respectively coupled to the Y electrode of the panel capacitor Cp.

An anode of the diode D3 may be coupled to a source of the transistor Ypr, and a cathode thereof may be coupled to the first terminal of the inductor Lp. A cathode of the diode D4 may be coupled to the drain of the transistor Ypf, and an anode thereof may be coupled to the first terminal of the inductor Lp. An anode of the diode D5 may be coupled to a source of the transistor Ynr, and a cathode thereof may be coupled to the first terminal of the inductor Ln. A cathode of the diode D6 may be coupled to the drain of the transistor Ynf, and an anode thereof may be coupled to the first terminal of the inductor Ln.

The diodes D3 and D5 may block a current path formed due to body diodes of the transistors Ypr and Ynr, and may form a rising path along which a voltage of the Y electrode may be increased. The diodes D4 and D6 may block a current path formed due to body diodes of the transistors Ypf and Ynf, and may form a falling path along which the voltage of the Y electrode may be decreased.

It is one example that the inductors Lp and Ln may be respectively coupled to the respective rising and falling paths in FIG. 11. For example, the inductors may be respectively coupled between each transistor Ypr, Ypf, Ynr, and Ynf and each diode D3, D4, D5, and D6.

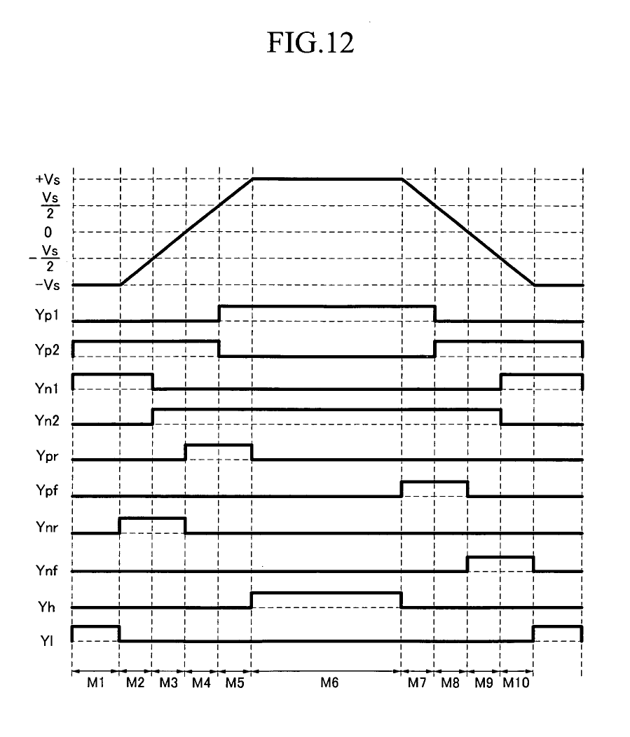

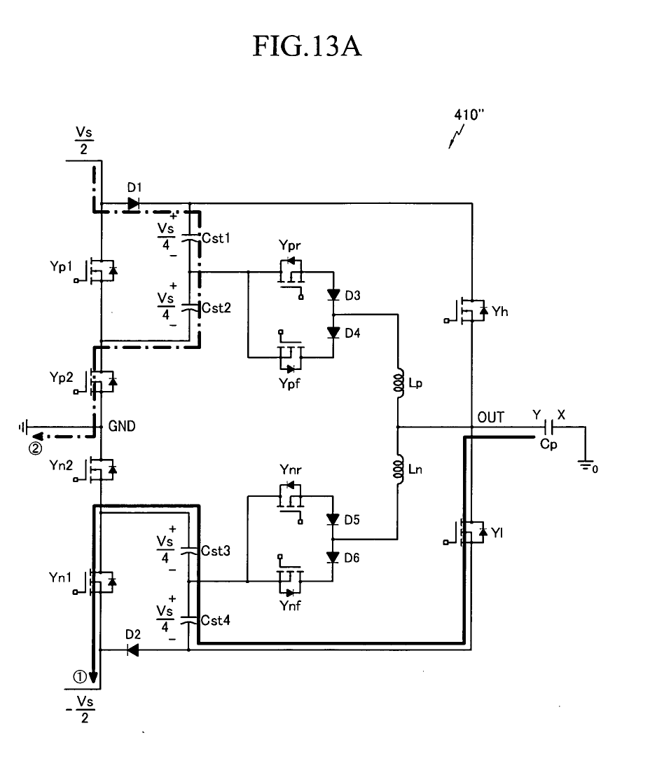

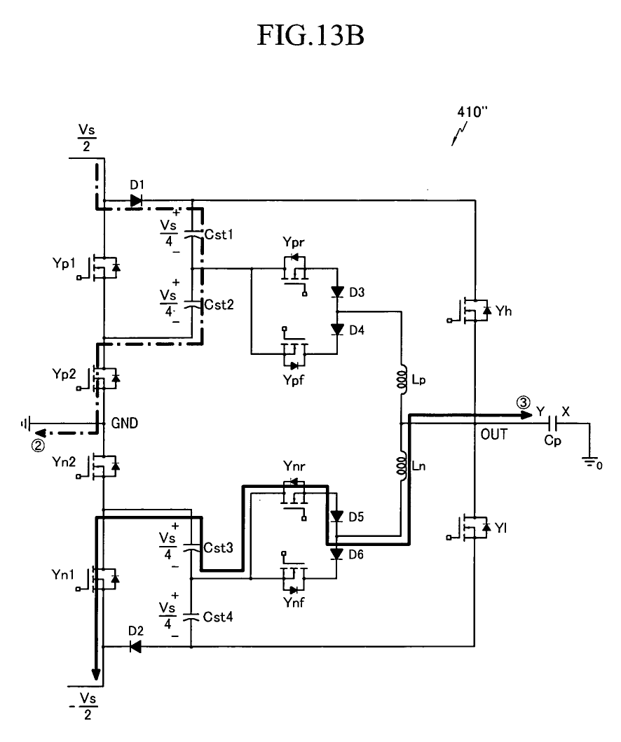

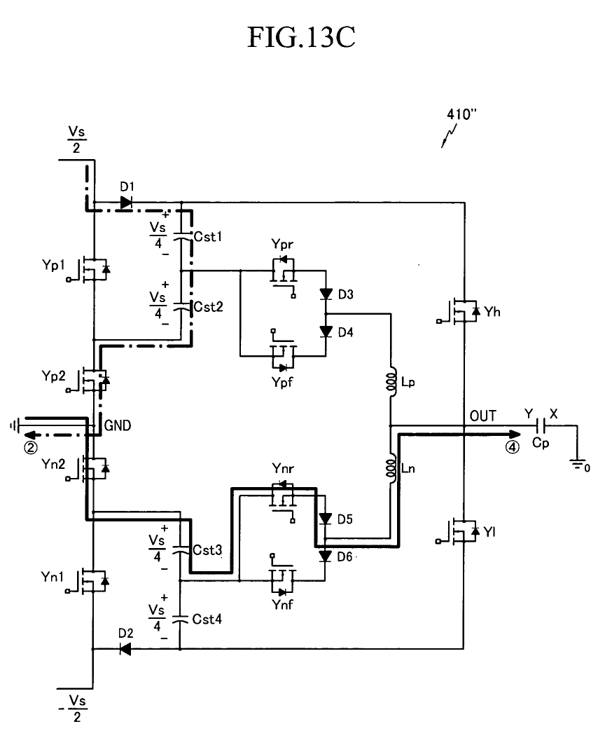

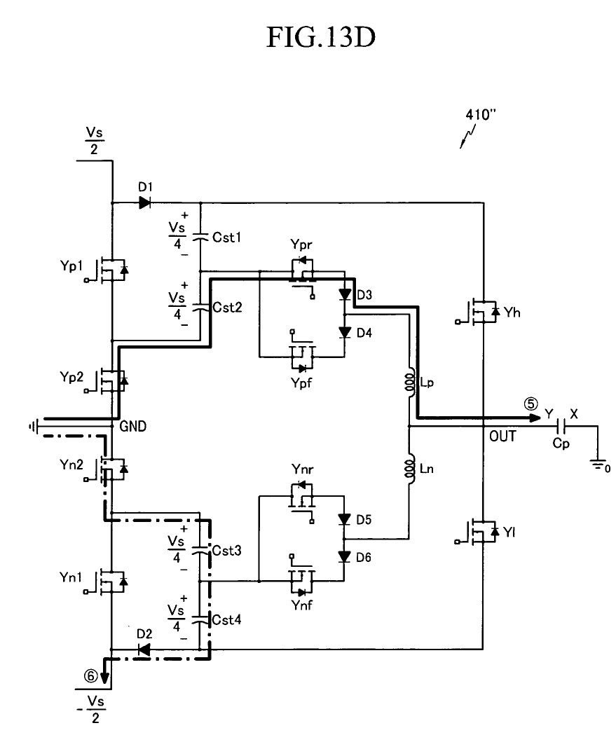

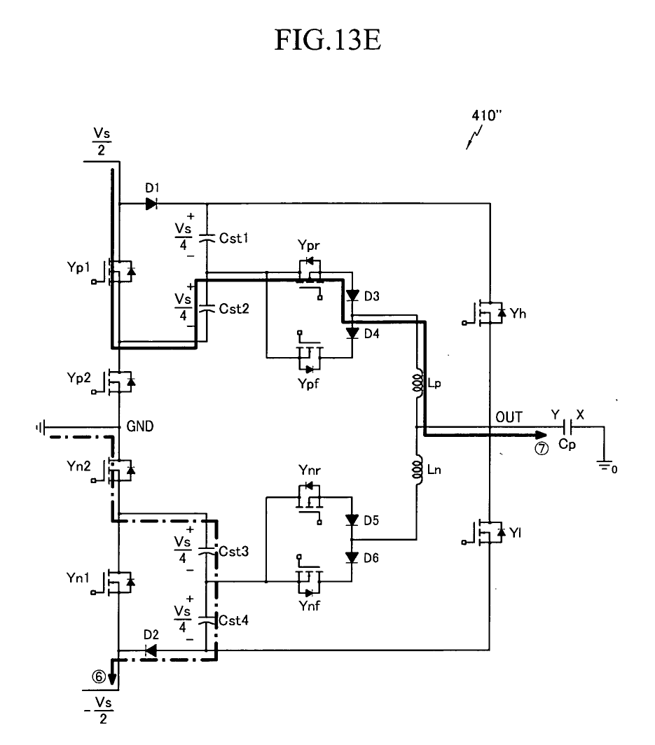

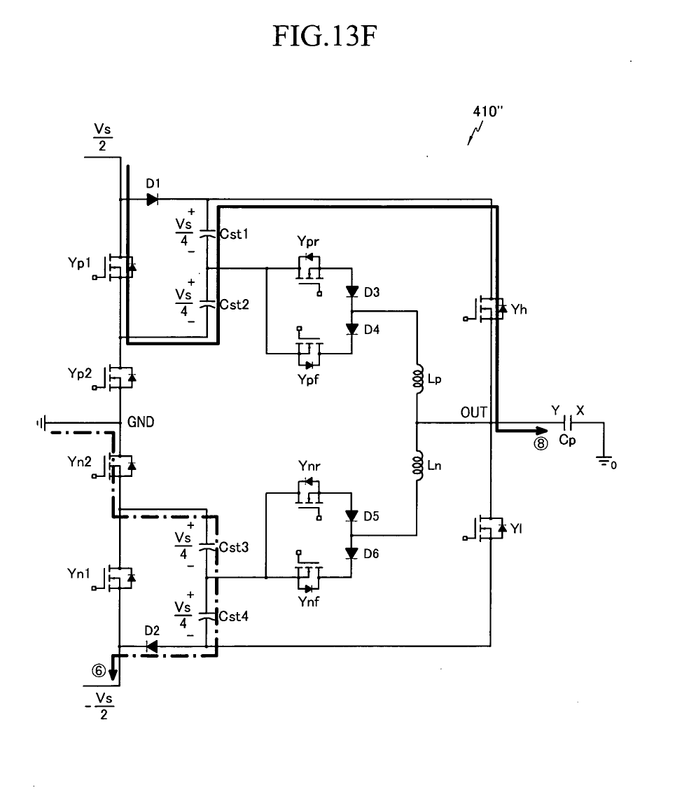

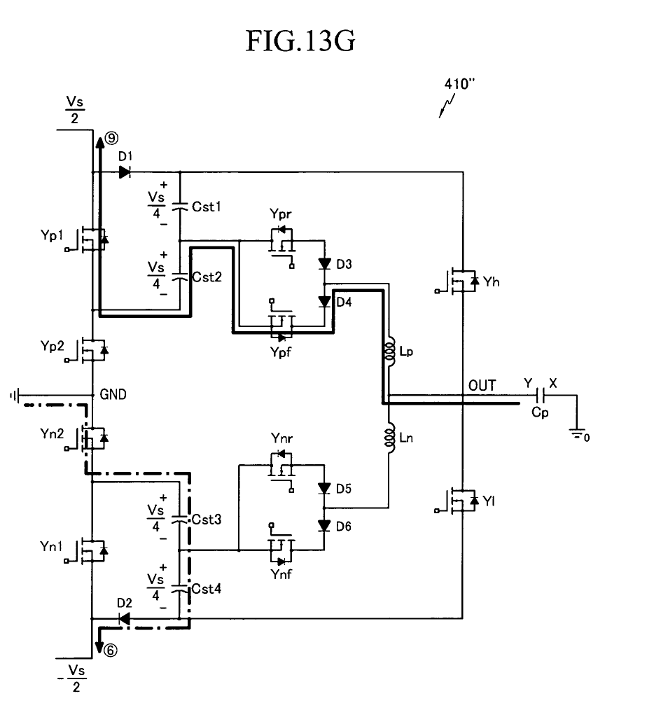

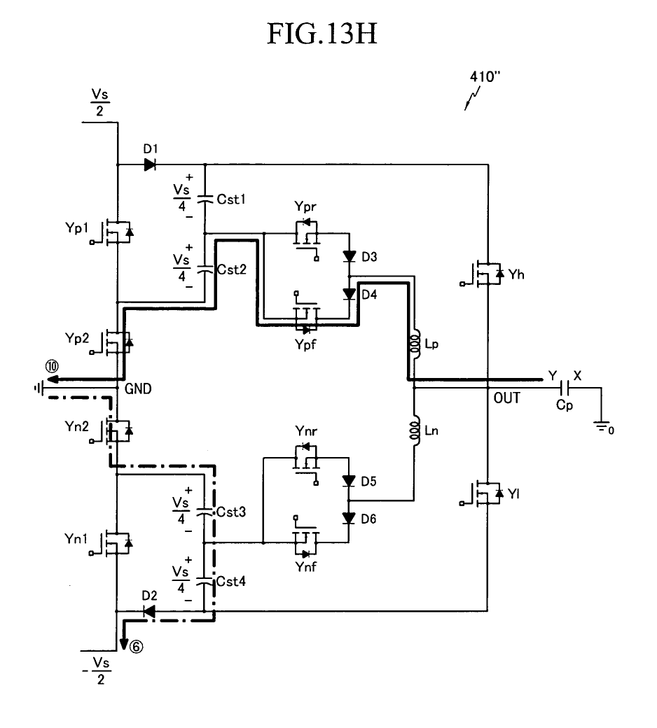

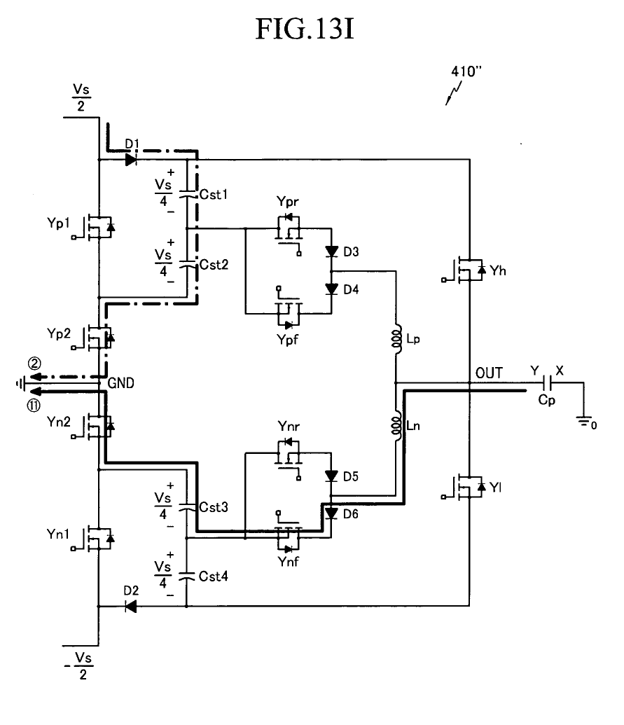

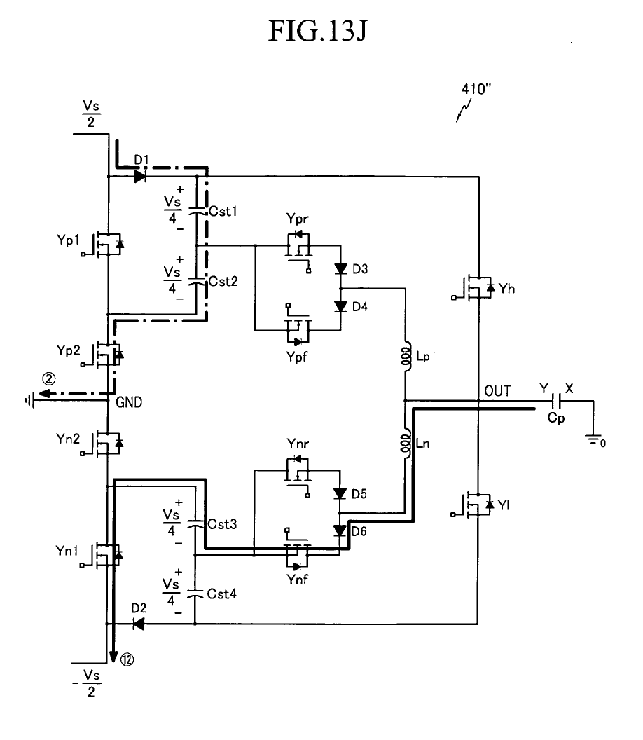

Next, an exemplary operation of the sustain discharge driving circuit 410″ for generating a sustain pulse according to the third driving waveform will be described in detail with reference to FIGS. 12 and 13A to 13F.

FIG. 12 shows an exemplary timing diagram employable by the third exemplary embodiment of the sustain discharge driving circuit shown in FIG. 11. FIG. 13A to FIG. 13J respectively show exemplary current paths corresponding to respective operation modes of the third exemplary embodiment of the sustain discharge driving circuit shown in FIG. 11.

In the following description, it is assumed that the transistors Yp2, Yn1, and Yn1 are turned on before a first mode M1 starts.

During the first mode M1, the transistor Yn1 may be turned off and the transistor Yl may be turned on. As shown in FIG. 13A, a first current path \textcircled{0} may be formed through the Y electrode of the panel capacitor Cp, the transistor Yl, the capacitor Cst4, the capacitor Cst3, the transistor Yn1, and the power source −Vs/2. Accordingly, the voltage −Vs may be applied to the Y electrode through the first current path \textcircled{1}. That is, e.g., the Y electrode may be applied with the voltage −Vs that may be lower than the power source voltage −Vs/2 by, e.g., as much as the total voltage Vs/2 charged at the capacitors Cst3 and Cst4.

Because the transistor Yp1 may be turned off and the transistor Yp2 may be turned on during the first mode M1, a second current path \textcircled{2} may be formed through the power source Vs/2, the diode D1, the capacitor Cst1, the capacitor Cst2, the transistor Yp2, and the ground terminal GND. Accordingly, the voltage Vs/2 corresponding to a difference between the Vs/2 and 0 V voltages of the Vs/2 power source and the ground terminal GND may be divided in half, and the voltage Vs/4 may be charged at the respective capacitors Cst1 and Cst2.

The source of the transistor Yh may have the voltage −Vs through the first current path \textcircled{1} and the drain of the transistor Yh may have the voltage Vs/2 through the second current path \textcircled{2}, and accordingly, the voltage 3Vs/2 may be formed between the source and drain of the transistor Yh. Thus, the transistor Yh may be a transistor having a withstand voltage of 3Vs/2.

Because the voltage of the source of the transistor Yp1 may be 0 V and the voltage of the drain of the transistor Yp1 may be the voltage Vs/2, the transistor Yp1 may be a transistor having a withstand voltage of Vs/2. In addition, because the voltage of the drain of the transistor Yn2 may be 0 V and the voltage of the source of the transistor Yn2 may be the voltage −Vs/2, the transistor Yp1 may be a transistor having a withstand voltage of Vs/2.

Referring to FIG. 13B, during the second mode M2, the transistor Yl may be turned off and the transistor Ynr may be turned on. Then, a third current path \textcircled{3} may be formed through the power source −Vs/2, the transistor Yn1, the capacitor Cst3, the transistor Ynr, the diode D5, the inductor Ln, and the Y electrode of the panel capacitor Cp. The inductor Ln and the panel capacitor Cp of the third current path \textcircled{3} may generate an LC resonance. Accordingly, the voltage of the Y electrode of the panel capacitor Cp may be increased from the voltage −Vs to −Vs/2.

Referring to FIG. 13C, during a third mode M3, the transistor Yn1 may be turned off and the transistor Yn2 may be turned on, and accordingly, a fourth current path \textcircled{4} may be formed through the ground terminal GND, the transistor Yn2, the capacitor Cst3, the transistor Ynr, the diode D5, the inductor Ln, and the Y electrode of the panel capacitor Cp. The inductor Ln and the panel capacitor Cp of the fourth current path \textcircled{4} generate an LC resonance. Accordingly, the voltage of the Y electrode of the panel capacitor Cp may be increased from the voltage −Vs/2 to 0 V.

Next, referring to FIG. 13D, during a fourth mode M4, the transistor Ynr may be turned off and the transistor Ypr may be turned on. As shown in FIG. 13D, a fifth current path \textcircled{5} may be formed through the ground terminal GND, the transistor Yp2, the capacitor Cst2, the transistor Ypr, the diode D3, the inductor Lp, and the Y electrode of the panel capacitor Cp. The inductor Lp and the panel capacitor Cp of the fifth current path \textcircled{5} may generate a resonance. Accordingly, the voltage of the Y electrode of the panel capacitor Cp may be increased from 0 V to the voltage Vs/2.

Referring to FIG. 13D, during the fourth mode M4, a sixth current path \textcircled{6} may be formed through the ground terminal GND, the transistor Yn2, the capacitor Cst3, the capacitor Cst4, the diode D2, and the power source −Vs/2 as shown in FIG. 13D. Accordingly, the voltage Vs/2 corresponding to a difference between 0 V and −Vs/2 voltages of the ground terminal GND and the voltage source −Vs/2 may be divided in half, and the voltage Vs/4 may be charged at the respective capacitors Cst3 and Cst4.

Referring to FIG. 13E, during a fifth mode M5, the transistor Yp2 may be turned off and the transistor Yp1 may be turned on. Then, as shown in FIG. 13E, a seventh current path \textcircled{7} may be formed through the power source Vs/2, the transistor Yp1, the capacitor Cst2, the transistor Ypr, the diode D3, the inductor Lp, and the Y electrode of the panel capacitor Cp. The inductor Lp and the panel capacitor Cp of the seventh current path \textcircled{7} may generate a resonance. Accordingly, the voltage of the Y electrode of the panel capacitor Cp may be increased from the voltage Vs/2 to the voltage Vs.

Referring to FIG. 13F, during a sixth mode M6, the transistor Ypr may be turned off and the transistor Yh may be turned on. Then, as shown in FIG. 13F, an eighth current path \textcircled{8} may be formed through the power source Vs/2, the transistor Yp1, the capacitor Cst2, the capacitor Cst1, the transistor Yh, and the Y electrode of the panel capacitor Cp. The inductor Lp and the panel capacitor Cp of the eighth current path \textcircled{8} may generate a resonance. That is, the Y electrode may be applied with the voltage Vs that is higher than the power source voltage Vs/2 by, e.g., as much as the total voltage Vs/2 charged at the capacitor Cst1 and Cst2.

During the sixth mode M6, the sixth current path \textcircled{6} may be formed through the transistor Yn2, the capacitor Cst3, the capacitor Cst4, the diode D2, and the power source −Vs/2. Accordingly, because the sixth current path \textcircled{6} may apply the voltage −Vs/2 to the source of the transistor Yl and the eighth current path \textcircled{8} may apply the voltage Vs to the drain of the transistor Yl, the voltage 3Vs/2 may be applied between the source and drain of the transistor Yl. Thus, the transistor Yl may be a transistor having a withstand voltage 3Vs/2.

Because the source voltage of the transistor Yp2 may be 0 V and the drain voltage of the transistor Yp2 may be the voltage Vs/2, the transistor Yp2 may be a transistor having a withstand voltage Vs/2. In addition, because the drain voltage of the transistor Yn1 may be 0 V and the source voltage of the transistor Yn1 may be the voltage −Vs/2, the transistor Yn1 may be a transistor having a withstand voltage Vs/2.

Referring to FIG. 13G, during a seventh mode M7, the transistor Yh may be turned off and the transistor Ypf may be turned on, and accordingly, ninth current path \textcircled{9} may be formed though the Y electrode of the panel capacitor Cp, the inductor Lp, the diode D4, the transistor Ypf, the capacitor Cst2, the transistor Yp1, and the power source Vs/2. The inductor Lp and the panel capacitor Cp of the ninth current path \textcircled{9} may generate an LC resonance. Energy stored at the panel capacitor Cp may be recovered along a path though the inductor Lp to the ground terminal GND and the voltage of the Y electrode may be decreased from the voltage Vs to the voltage Vs/2.

Referring to FIG. 13H, during an eighth mode M8, the transistor Yn1 may be turned off and the transistor Yn2 may be turned on. Then, a tenth current path \textcircled{10} may be formed through the Y electrode of the capacitor Cp, the inductor Lp, the diode D4, the transistor Ypf, the capacitor Cst2, the transistor Yp2, and the ground terminal GND. The inductor Lp and the panel capacitor Cp of the tenth current path \textcircled{10} may generate an LC resonance. Accordingly, the voltage of the Y electrode of the panel capacitor Cp may be decreased from the voltage Vs/2 to 0 V.

Referring to FIG. 13I, during a ninth mode M9, the transistor Ypf may be turned off and the transistor Ynf may be turned on. As shown in FIG. 13I, an eleventh current path \textcircled{11} may be formed through the Y electrode of the panel capacitor Cp, the inductor Ln, the diode D6, the transistor Ynf, the capacitor Cst3, the transistor Yn2, and the power source 0 V. The inductor Ln and the panel capacitor Cp of the eleventh current path \textcircled{11} may generate an LC resonance. Accordingly, the voltage of the Y electrode of the panel capacitor Cp may be decreased from 0 V to the voltage −Vs/2.

Similarly to FIGS. 13A, 13B and 13C, as shown in FIG. 13J, during the ninth mode M9, the current path \textcircled{2} may be formed and accordingly, the voltage Vs/2 corresponding to a difference between voltages of the power sources 0 and Vs/2 may be divided in half and the voltage Vs/4 may be charged at the respective capacitors Cst1 and Cst2.

Referring to FIG. 13J, during a tenth mode M10, the transistor Yn2 may be turned off and the transistor Yn1 may be turned on. Then, as shown in FIG. 13J, a twelfth current path \textcircled{12} may be formed through the Y electrode of the panel capacitor Cp, the inductor Ln, the diode D6, the transistor Ynf, the capacitor C3, the transistor Yn1, and the power source −Vs/2. The inductor Ln and the panel capacitor Cp of the twelfth current path \textcircled{12} may generate a resonance. Accordingly, the voltage of the Y electrode of the panel capacitor Cp may be decreased from the voltage −Vs/2 to the voltage −Vs.

As such, during the sustain period, the first to tenth modes M1 to M10 may be repeated by the predetermined number of times corresponding to a weight value of the corresponding subfield, and accordingly, the Y electrode may be alternately applied with the voltages Vs and −Vs. The transistors Yh and Yl may use a transistor having a withstand voltage 3Vs/2 corresponding to ¾ of the voltage applied to the Y electrode, and the transistors Yp1, Yp2, Yn1, and Yn2 may use a transistor having a withstand voltage Vs/2.

Next, with reference to FIG. 11, a sustain discharge driving circuit for generating a sustain pulse according to the first driving waveform shown in FIG. 2 will be described.

To generate a sustain pulse according to the first driving waveform shown in FIG. 2, a sustain discharge driving circuit similar to the sustain discharge driving circuit 410″ of FIG. 11, but with a controlled power source voltage level(s) may be employed. Such a sustain discharge driving circuit having the controlled power source voltage level(s) may be provided at each of the scan electrode driver 400 and the sustain electrode driver 500.

More particularly, the sustain discharge driving circuit for generating a sustain pulse according to the first driving waveform of FIG. 2 may employ the exemplary sustain discharge driving circuit 410″ illustrated in FIG. 11, however, e.g., a voltage of the power source coupled to the drain of the transistor Yp1 may be set to a voltage 3Vs/4, the ground terminal GND may be replaced by the voltage Vs/2, and a voltage of the power source coupled to the source of the transistor Yn1 may be set to a voltage Vs/4.

As a result, when the transistors Yp1 and Yn1 are respectively turned off and the transistors Yp2 and Yn2 are respectively turned on, the capacitors Cst1, Cst2, Cst3, and Cst4 are respectively charged at the voltage Vs/4 and the sustain pulse alternately having voltages Vs and 0 may be applied to the Y electrode through the same paths shown in FIGS. 13A to 13J.

A sustain discharge driving circuit for generating a sustain pulse for the second driving waveform shown in FIG. 3 will now be described with reference to FIG. 11.

To generate the sustain pulse according to the second driving waveform shown in FIG. 3, a sustain discharge driving circuit similar to the sustain discharge driving circuit 410″ of FIG. 11, but with a controlled power source voltage level(s) may be employed. Such a sustain discharge driving circuit having the controlled power source voltage level(s) may be provided at each of the scan electrode driver 400 and the sustain electrode driver 500.

More particularly, the sustain discharge driving circuit for generating a sustain pulse according to the second driving waveform of FIG. 3 may employ the circuit illustrated in FIG. 11, however, e.g., a voltage of the power source coupled to the drain of the transistor Yp1 may be set to a voltage Vs/4 and a voltage of the power source coupled to the source of the transistor Yn1 may be set to a voltage −Vs/4.

As a result, when the transistors Yp1 and Yn1 are respectively turned off and the transistors Yp2 and Yn2 are respectively turned on, the capacitors Cst1, Cst2, Cst3, and Cst4 may be respectively charged at the voltage Vs/4 and the sustain pulse alternately having voltages Vs/2 and −Vs/2 may be applied to the Y electrode through the same paths shown in FIGS. 13A to 13J.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to an exemplary embodiment of the present invention, the sustain discharge driving circuit may use a transistor having a low withstand voltage thereby reducing a cost in comparison with the transistor having a higher withstand voltage.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A driver circuit for a display device including a plurality of first electrodes, the driver circuit comprising:
a first and a second transistor coupled in series between a first power source for supplying a first voltage and a second power source for supplying a second voltage that is lower than the first voltage;
a third and a fourth transistor coupled in series between the second power source and a third power source for supplying a third voltage that is lower than the second voltage;
a first charging power source coupled between the first power source and a node of the first and second transistors;
a first charging path being coupled between the first power source and the first charging power source, for charging the first charging power source when the second transistor is turned on;
a second charging power source coupled between the third power source and a node of the third and fourth transistors;
a second charging path being coupled between the third power source and the second charging power source, for charging the second charging power source when the third transistor is turned on;
a fifth transistor coupled between the plurality of first electrodes and a node of the first charging path and the first charging power source;
a sixth transistor coupled between the plurality of first electrodes and a node of the second charging path and the second charging power source;
at least one inductor having a first terminal coupled to the plurality of first electrodes; and
at least one path separator having a first node coupled to one of the first charging power source, the second charging power source, and the second power source, and a second node coupled to a second terminal of the one inductor, for separating a first current path from the first node to the second node and a second current path from the second node to the first node,
wherein the first node is coupled to the second power source in the case of the at least one path separator being a single separator and the first node is coupled to the first and second charging power source in the case of the at least one path separator being a plurality of separators.

2. The driver circuit as claimed in claim 1, wherein the first current path includes a seventh transistor having a first terminal coupled to the first node and a first diode having an anode coupled to a second terminal of the seventh transistor and a cathode coupled to the second terminal of the inductor, and
the second current path includes an eighth transistor having a second terminal coupled to the first node and a second diode having a cathode coupled to a first terminal of the eighth transistor and an anode coupled to the second terminal of the inductor.

3. The driver circuit as claimed in claim 2, wherein the number of path separators is equal to the number of inductors.

4. The driver circuit as claimed in claim 3, wherein in the case of there being two path separators,
the first and second charging power sources respectively include first and second capacitors for charging a same voltage and that are coupled in series, and
a first node of the respective path separators is coupled to a node of the first and second capacitors.

5. The driver circuit as claimed in claim 3, wherein in the case of there being two path separators, the first and second charging power sources respectively include a third capacitor, the first node of the one path separator is coupled to a node of the first and second transistors, and the first node of the other path separator is coupled to a node of the third and fourth transistors.

6. The driver circuit as claimed in claim 1, wherein the first charging path includes a third diode having an anode coupled to the first power source and a cathode coupled to the first charging power source.

7. The driver circuit as claimed in claim 6, wherein
the second charging path includes a fourth diode having a cathode coupled to the third power source and an anode coupled to the second charging power source.

8. The driver circuit as claimed in claim 1, wherein in the case of there being one path separator,
the fourth and sixth transistors are turned on and the plurality of first electrodes are applied with a fourth voltage corresponding to a difference between the third voltage and a voltage charged at the second capacitor,
the sixth transistor is turned off and a seventh transistor is turned on so that the voltage of the plurality of first electrodes is increased to a fifth voltage that is higher than the fourth voltage,
the fourth transistor is then turned off and the first transistor is turned on so that the voltage of the plurality of first electrodes is additionally increased to a sixth voltage that is higher than the fifth voltage, and
the seventh transistor is turned off and the fifth transistor is turned on so that the plurality of first electrodes is applied with a voltage corresponding to the sum of the first voltage and the voltage charged at the first capacitor.

9. The driver circuit as claimed in claim 8, wherein
the plurality of first electrodes is applied with the fourth voltage and the second transistor is turned on while the voltage of the plurality of first electrodes is increased from the fourth voltage to the fifth voltage so that the first capacitor charges a voltage corresponding to a difference between the first voltage and the second voltage, and
the third transistor is turned on while the voltage of the plurality of first electrodes is increased from the fifth voltage to the sixth voltage so that the second capacitor is charged at a voltage corresponding to a difference between the second voltage and the third voltage.

10. The driver circuit as claimed in claim 9, wherein
while the first and fifth transistors are turned on and the plurality of first electrodes are applied with a fourth voltage corresponding to a difference between the first voltage and a voltage charged at the first capacitor,
the fifth transistor is turned off and an eighth transistor is turned on so that the voltage of the plurality of first electrodes is decreased to a fifth voltage that is lower than the fourth voltage,
the first transistor is then turned off and the fourth transistor is turned on so that the voltage of the plurality of first electrodes is additionally decreased to a sixth voltage that is lower than the fifth voltage, and
the eighth transistor is turned off and the sixth transistor is turned on and the plurality of first electrodes is applied with a voltage corresponding to the sum of the first voltage and the voltage charged at the second capacitor.

11. The driver circuit as claimed in claim 10, wherein
the plurality of first electrodes is applied with the fourth voltage and the third transistor is turned on while the voltage of the plurality of first electrodes is decreased from the fourth voltage to the fifth voltage so that the second capacitor is charged at a voltage corresponding to a difference between the first voltage and the second voltage, and
the second transistor is turned on while the voltage of the plurality of first electrodes is decreased from the fifth voltage to the sixth voltage so that the first capacitor is charged at a voltage corresponding to a difference between the first voltage and the second voltage.

12. The driver circuit as claimed in claim 4, wherein
while the fourth and sixth transistors are turned on and the plurality of first electrodes are applied with a fourth voltage corresponding to a difference between the third voltage and a voltage charged at the second capacitor,
the sixth transistor is turned off and a ninth transistor is turned on so that the voltage of the plurality of first electrodes is increased to a fifth voltage,
the fourth transistor and the ninth transistor are then turned off and the first transistor and the seventh transistor are turned on so that the voltage of the plurality of first electrodes is additionally increased to a sixth voltage that is higher than the fourth voltage, and
the seventh transistor is turned off and the fifth transistor is turned on so that the plurality of first electrodes are applied with a voltage corresponding to the sum of the first voltage and the voltage charged at the first capacitor.

13. The driver circuit as claimed in claim 12, wherein the plurality of first electrodes are applied with the fourth voltage and the second transistor is turned on while the voltage of the plurality of first electrodes is increased from the fourth voltage to the fifth voltage so that the first capacitor is charged at a voltage corresponding to a difference between the first voltage and the second voltage, and
the third transistor is turned on while the voltage of the plurality of first electrodes is increased from the fifth voltage to the sixth voltage so that the second capacitor is charged at a voltage corresponding to a difference between the second voltage and the third voltage.

14. The driver circuit as claimed in claim 13, wherein
while the first and fifth transistors are turned on and the plurality of first electrodes are applied with a fourth voltage corresponding to a difference between the first voltage and a voltage charged at the first capacitor,
the fifth transistor is turned off and the eighth transistor is turned on so that the voltage of the plurality of first electrodes is decreased to a fifth voltage that is lower than the fourth voltage,
and then the first transistor and the eighth transistor are turned off and the fourth transistor and a tenth transistor are turned on so that the voltage of the plurality of first electrodes is additionally decreased to a sixth voltage that is lower than the fifth voltage, and
the tenth transistor is turned off and the sixth transistor is turned on so that the plurality of first electrodes are applied with a voltage corresponding to the sum of the third voltage and the voltage charged at the second capacitor.

15. The driver circuit as claimed in claim 14, wherein
the plurality of first electrodes are applied with the fourth voltage and the third transistor is turned on while the voltage of the plurality of first electrodes is decreased to the fifth voltage so that the second capacitor is charged at a voltage corresponding to a difference between the second voltage and the third voltage, and
the second transistor is turned on while the voltage of the plurality of first electrodes is decreased from the fifth voltage to the sixth voltage so that the first capacitor is charged at a voltage corresponding to a difference between the first voltage and the second voltage.

16. The driver circuit as claimed in claim 5, wherein
while the fourth and sixth transistors are turned on and the plurality of first electrodes are applied with a fourth voltage corresponding to a difference between the third voltage and a voltage charged at the second capacitor,
the sixth transistor is turned off and a ninth transistor is turned on so that the voltage of the plurality of first electrodes is increased, and then the fourth transistor is turned off and the third transistor is turned on so that the voltage of the plurality of first electrodes is additionally increased to the fifth voltage that is higher than the fourth voltage,
the third and ninth transistors are turned off and the second and seventh transistors are turned on so that the voltage of the plurality of first electrodes is additionally increased,
the second transistor is turned off and the first transistor is turned on so that the voltage of the plurality of first electrodes is additionally increased to the sixth voltage that is higher than the fifth voltage, and
the seventh transistor is turned off and the fifth transistor is turned on so that the plurality of first electrodes are applied with a voltage corresponding to the sum of the first voltage and the voltage charged at the first and second capacitors.

17. The driver circuit as claimed in claim 16, wherein
the plurality of first electrodes is applied with the fourth voltage and the second transistor is turned on while the voltage of the plurality of first electrodes is increased from the fourth voltage to the fifth voltage so that the first and second capacitors are charged at a voltage corresponding to a difference between the first voltage and the second voltage, and
the third transistor is turned on while the voltage of the plurality of first electrodes is increased from the fifth voltage to the sixth voltage so that the third and fourth capacitors are charged at a voltage corresponding to a difference between the second voltage and the third voltage.

18. The driver circuit as claimed in claim 17, wherein
while the first and fifth transistors are turned on so that the plurality of first electrodes are applied with a fourth voltage corresponding to the sum of the first voltage and a voltage charged at the first and second capacitors,
the fifth transistor is turned off and the eighth transistor is turned on so that the voltage of the plurality of first electrodes is decreased,
the first transistor is then turned off and the second transistor is turned on so that the voltage of the plurality of first electrodes is additionally decreased to the fifth voltage that is lower than the fourth voltage,
the second and eighth transistors are turned off and the third transistor and a tenth transistor are turned on so that the voltage of the plurality of first electrodes is additionally decreased,
the third transistor is turned off and the fourth transistor is turned on so that a voltage of the plurality of first electrodes is additionally decreased to the sixth voltage (−Vs) that is lower than the fifth voltage, and
the tenth transistor is turned off and the sixth transistor is turned on so that the plurality of first electrodes are applied with a voltage corresponding to a difference between the third voltage and the voltage charged at the third and fourth capacitors.

19. The driver circuit as claimed in claim 18, wherein:
the plurality of first electrodes are applied with the fourth voltage and the third transistor is turned on while the voltage of the plurality of first electrodes is decreased from the fourth voltage to the fifth voltage so that the third and fourth capacitors are charged at a voltage corresponding to a difference between the second voltage and the third voltage, and
the second transistor is turned on while the voltage of the plurality of first electrodes is decreased from the fifth voltage to the sixth voltage so that the first and second capacitors are charged at a voltage corresponding to a difference between the first voltage and the second voltage.

20. A driving method for driving a display including a plurality of first electrodes and a plurality of second electrodes, the driving method comprising:
applying a third voltage to the plurality of first electrodes through a first power source for supplying a first voltage and a first capacitor charged at a second voltage;
increasing a voltage of the plurality of first electrodes through a first resonance path including a second power source for supplying a fourth voltage that is higher than the first voltage and a first inductor by forming a first path including the first capacitor and the first power source;
additionally increasing a voltage of the plurality of first electrodes through the first resonance path by forming a second path including a third power source for supplying a fifth voltage that is higher than a fourth voltage and a second capacitor charged at a sixth voltage;
applying a seventh voltage corresponding to the sum of the fifth and sixth voltages to the plurality of first electrodes;
decreasing a voltage of the plurality of first electrodes through a second resonance path including a second inductor and the second power source by forming a third path including the third power source and the second capacitor; and
additionally decreasing a voltage of the plurality of first electrodes through the second resonance path by forming a fourth path including the first capacitor and the first power source.

21. The driving method as claimed in claim 20, wherein the first resonance path further comprises a first transistor coupled between the second power source and the first inductor, and the second resonance path further comprises a second transistor coupled between the second power source and the second inductor.

22. The driving method as claimed in claim 21, wherein the first resonance path further includes a third transistor between a first terminal of the first capacitor and the plurality of first electrodes and the second resonance path further includes a fourth transistor between a first terminal of the second capacitor and the plurality of first electrodes.

23. The driving method as claimed in claim 22, wherein:
applying the third voltage to the plurality of first electrodes and forming the first path includes charging a sixth voltage at the second capacitor through a first charging path including the third power source, the second capacitor, and the second power source, and
forming the second path includes charging a second voltage at the first capacitor through a second charging path including the second power source, the first capacitor, and the first power source.

24. The driving method as claimed in claim 23, wherein:
applying the seventh voltage to the plurality of first electrodes and forming the third path includes charging a second voltage at the first capacitor through the second charging path, and
forming the fourth path includes charging a sixth voltage at the second capacitor through the first charging path.

25. A driving method for driving a display including a plurality of first electrodes and a plurality of second electrodes, the driving method comprising:
applying a third voltage to the plurality of first electrodes through a first power source for supplying a first voltage and a first capacitor charged at a second voltage;
increasing a voltage of the plurality of first electrodes through a first resonance path including the first power source and a first inductor;
additionally increasing a voltage of the plurality of first electrodes through a second resonance path including a second power source for supplying a fourth voltage that is higher than the first voltage and a second inductor;
applying a sixth voltage to the plurality of first electrodes through the second power source and a second capacitor charged at a fifth voltage;
decreasing a voltage of the plurality of first electrodes through a third resonance path including the second power source and the second inductor; and
additionally decreasing a voltage of the plurality of first electrodes through a fourth resonance path including the first inductor and the first capacitor.

26. The driving method as claimed in claim 25, wherein:
the first resonance path further includes a first transistor coupled between the second power source and the first inductor,
the second resonance path further includes a second transistor coupled between the second power source and the second inductor,
the third resonance path further includes a third transistor coupled between the second power source and the second inductor, and
the fourth resonance path further includes a fourth transistor coupled between the first power source and the first inductor.

27. The driving method as claimed in claim 26, wherein increasing or decreasing the voltage of the plurality of first electrodes through the first and fourth paths includes charging the fifth voltage at the second capacitor through a charging path including the second power source, the second capacitor, and the third power source for supplying a seventh voltage that is higher than the first voltage and lower than the fourth voltage.

28. The driving method as claimed in claim 27, wherein increasing or decreasing the voltage of the plurality of first electrodes through the second and third paths includes charging the second voltage at the first capacitor through a charging path including the third power source, the first capacitor, and the first power source.

29. A driving method for driving a display including a plurality of first electrodes and a plurality of second electrodes, the driving method comprising:
applying a third voltage to the plurality of first electrodes through a first power source for supplying a first voltage and first and second capacitors charged at a second voltage;
increasing a voltage of the plurality of first electrodes through a first resonance path including the first power source and a first inductor;
additionally increasing a voltage of the plurality of first electrodes through a second resonance path including a second power source for supplying a fourth voltage that is higher than the first voltage and the first inductor;
additionally increasing a voltage of the plurality of first electrodes through a third resonance path including the second power source and a second inductor;
additionally increasing a voltage of the plurality of first electrodes through a second resonance path including a third power source for supplying a fifth voltage that is higher than the fourth voltage and the second inductor;
applying a seventh voltage to the plurality of first electrodes through the third power source, third capacitor, and fourth capacitor, the third and fourth capacitors being charged at a sixth voltage;
decreasing a voltage of the plurality of first electrodes through a fifth resonance path including the third power source and the second inductor;
additionally decreasing a voltage of the plurality of first electrodes through a sixth resonance path including the second power source and the second inductor;
additionally decreasing a voltage of the plurality of first electrodes through a seventh resonance path including the second power source and the first inductor; and
additionally increasing a voltage of the plurality of first electrodes through an eighth resonance path including the first power source and the first inductor.

30. The driving method as claimed in claim 29, wherein:
the first resonance path further includes a first transistor coupled between the first power source and the first inductor,
the second resonance path further includes the first transistor coupled between the second power source and the first inductor,
the third resonance path further includes a second transistor coupled between the second power source and the second inductor,
the fourth resonance path further includes the second transistor coupled between the second power source and the second inductor,
the fifth resonance path further includes a third transistor coupled between the third power source and the second inductor,
the sixth resonance path further includes the third transistor coupled between the second power source and the second inductor,
the seventh resonance path further includes a fourth transistor coupled between the second power source and the first inductor, and
the eighth resonance path further includes the fourth transistor coupled between the first power source and the first inductor.

31. The driving method as claimed in claim 30, wherein the increasing or decreasing the voltage of the plurality of first electrodes through the first, second, seventh, or eighth paths including charging the sixth voltage at the third and fourth capacitors through a charging path including the third power source, the third and fourth capacitors, and the second power source.

32. The driving method as claimed in claim 31, wherein increasing or decreasing the voltage of the plurality of first electrodes through the first, second, seventh, or eighth paths including charging the second voltage at the first and second capacitors through a charging path including the second power source, the first and second capacitors, and the first power source.
